(19) United States
(12) Patent Application Publication
(10) Pub. No.: US 2011/0052045 A1
(43) Pub. Date: Mar. 3, 2011

(54) IMAGE PROCESSING APPARATUS, IMAGE PROCESSING METHOD, AND COMPUTER READABLE MEDIUM

(75) Inventor: Hirokazu KAMEYAMA, Ashigarakama-gun (JP)

(73) Assignee: FUJIFILM Corporation, Tokyo (JP)

(21) Appl. No.: 12/896,051

(22) Filed: Oct. 1, 2010

Related U.S. Application Data
(63) Continuation of application No. PCT/JP2009/001577, filed on Apr. 3, 2009.

(30) Foreign Application Priority Data
Apr. 4, 2008 (JP) 2008-098761
Apr. 7, 2008 (JP) 2008-099748

(51) Int. Cl. G06K 9/00

(52) U.S. Cl. 382/154

(57) ABSTRACT

A system is provided to compress an image of a subject captured in a plurality of directions, at high compression, and the image processing apparatus includes: a model storage section that stores a reference model that is a three-dimensional model representing an object; a model generating section that generates, based on a plurality of captured images of an object, an object model that is a three-dimensional model that matches the object captured in the plurality of captured images; and an output section that outputs a position and a direction of the object captured in each of the plurality of captured images, in association with difference information between the reference model and the object model.

The contents of the following Japanese patent applications are incorporated herein by reference, NO. 2008-98761 filed on Apr. 4, 2008, NO. 2008-99748 filed on Apr. 7, 2008, NO. 2009-91321 filed on Apr. 3, 2009, and NO. 2009-91171 filed on Apr. 3, 2009.

### BACKGROUND

1. Technical Field

The present invention relates to an image processing apparatus, an image processing method, and a computer readable medium.

2. Related Art

A moving image encoding apparatus for encoding a moving image based on an overall movement of each segment constituting the moving image as well as on a fine movement of each characteristic point when moving each segment based on the overall movement is already known (e.g., Patent Document No. 1). Moreover, a system for searching for and checking a person using a database is known (e.g., Patent Document No. 2). Still more, a method of encoding and decoding an image of a face using a three-dimensional facial model and a fixed face resolution is known (e.g., Patent Document No. 3). In addition, an image encoding apparatus for transmitting, in advance, a main image and a plurality of sub-images representing change in a mouth portion in the main image, and thereafter transmitting a encoding language for designating which of the plurality of sub-images should be selected to be combined on the main image for reproducing a moving image is known (e.g., Patent Document No. 4).

The following shows the specifics of the patent documents cited above.
Patent Document No. 1: Japanese Patent Application Publication No. 8-153210
Patent Document No. 2: Japanese Patent Application Publication No. 2001-273496
Patent Document No. 3: Japanese Patent Application Publication No. 10-228544
Patent Document No. 4: Japanese Patent No. 2753599

### SUMMARY

However, when the entire region of an image is encoded, the amount of operation will increase. Another drawback related thereto is that the same object whose image has been captured in different directions cannot be efficiently taken advantage of.

Therefore, it is a first aspect of the innovations herein to provide An image processing apparatus including: a model storage section that stores a reference model that is a three-dimensional model representing an object; a model generating section that generates, based on a plurality of captured images of an object, an object model that is a three-dimensional model that matches the object captured in the plurality of captured images; and an output section that outputs a position and a direction of the object captured in each of the plurality of captured images, in association with difference information between the reference model and the object model.

An arrangement is also possible in which the model storage section stores a three-dimensional model representing an object using a feature parameter, the image processing apparatus further includes: a characteristic region detecting section that detects a characteristic region from a captured image; and a parameter value calculating section that calculates the value of a feature parameter in a three-dimensional model representing an object included in an image of a characteristic region, by adapting the image of the object included in the image of the characteristic region in the captured image to the three-dimensional model stored in the model storage section, and the output section outputs the value of the feature parameter calculated by the parameter value calculating section as well as the image of the region other than the characteristic region.

According to a second aspect of the innovations herein, provided is an image processing method including: storing a reference model that is a three-dimensional model representing an object; generating, based on a plurality of captured images of an object, an object model that is a three-dimensional model that matches the object captured in the plurality of captured images; and outputting a position and a direction of the object captured in each of the plurality of captured images, in association with difference information between the reference model and the object model.

According to a third aspect of the innovations herein, provided is a computer readable medium storing therein a program for an image processing apparatus, the program causing a computer to function as: a model storage section that stores a reference model that is a three-dimensional model representing an object; a model generating section that generates, based on a plurality of captured images of an object, an object model that is a three-dimensional model that matches the object captured in the plurality of captured images; and an output section that outputs a position and a direction of the object captured in each of the plurality of captured images, in association with difference information between the reference model and the object model.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an example of an image processing system 10 according to an embodiment.

FIG. 2 shows an example of a block configuration of an image processing apparatus 120.

FIG. 3 shows an example of a block configuration of a compression section 230.

FIG. 4 shows an example of a block configuration of an image processing apparatus 170.

FIG. 5 shows an example of another block configuration of the compression section 230.

FIG. 6 shows exemplary processing performed by the image processing apparatus 120.

FIG. 7 shows, in a table format, an example of data stored in a model storage section 270 and an allowable amount storage section 275.

FIG. 8 shows, in a table format, an example of data stored in an image DB 175 in association with a captured image 600.

FIG. 9 shows an example of an image processing system 20 according to another embodiment.

FIG. 10 shows an example of an image processing system 2010 according to an embodiment.

FIG. 11 shows an example of a block configuration of an image processing apparatus 2120.

FIG. 12 shows another example of a block configuration of a compression section 2230.

FIG. 13 shows an example of a block configuration of an image processing apparatus 2170.

FIG. 14 shows an example of another block configuration of the compression section 2230.

FIG. 15 shows an example of a characteristic point in a human face.

FIG. 16A and FIG. 16B schematically show an example of change in facial form when a weighting factor b is changed.

FIG. 17 shows an example of an image obtained by converting a sample image into an average facial form.

FIG. 18A and FIG. 18B schematically show an example of change in pixel value when a weighting factor q is changed.

FIG. 19 shows, in a table format, an example of a model stored in a model storage section 2270 and a model storage section 2350.

FIG. 20 shows an example of an image processing system 2020 according to another embodiment.

FIG. 21 shows an example of a hardware configuration of a computer 1500 functioning as an image processing apparatus 120, an image processing apparatus 170, an image processing apparatus 2120, and an image processing apparatus 2170.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

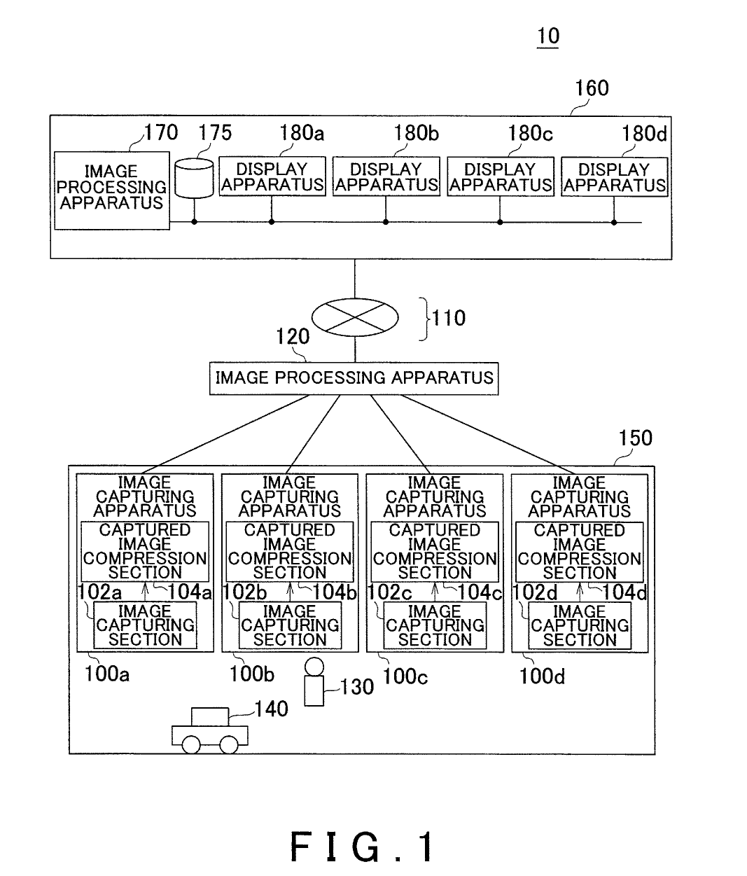

FIG. 1 shows an example of an image processing system 10 according to an embodiment. The image processing system 10 can function as a monitoring system as explained below.

The image processing system 10 includes a plurality of image capturing apparatuses 100a-d (hereinafter collectively referred to as “image capturing apparatus 100”) for capturing an image of a monitored space 150, an image processing apparatus 120 for processing the images captured by the image capturing apparatus 100, a communication network 110, an image processing apparatus 170, an image DB 175, and a plurality of display apparatuses 180a-d (hereinafter collectively referred to as “display apparatus 180”). The image processing apparatus 170 and the display apparatus 180 are provided in a space 160 different from the monitored space 150.

The image capturing apparatus 100a includes an image capturing section 102a and a captured image compression section 104a. The image capturing section 102a captures a plurality of images by successively capturing the monitored space 150. Note that the images captured by the image capturing section 102a may be images in RAW format. The captured image compression section 104a generates captured moving image data by synchronizing the images in RAW format captured by the image capturing section 102a, and compressing a captured moving image including the plurality of captured images obtained by the synchronization, using MPEG encoding or the like. In this way, the image capturing apparatus 100a generates captured moving image data by encoding the captured moving image obtained by capturing the image of the monitored space 150. The image capturing apparatus 100a outputs the captured moving image data to the image processing apparatus 120.

Since the image capturing apparatuses 100b, 100c, and 100d respectively have the same configuration as that of the image capturing apparatus 100a, the explanation of each constituting element of the image capturing apparatuses 100b, 100c, and 100d is not provided in the following. The image processing apparatus 120 obtains, from each image capturing apparatus 100, the captured moving image data generated by each image capturing apparatus 100.

Then, the image processing apparatus 120 obtains a captured moving image by decoding the captured moving image data obtained from the image capturing apparatus 100. The image processing apparatus 120 detects, from each of a plurality of captured images included in the obtained captured moving image, a plurality of characteristic regions having different characteristic types, such as a region including a person 130, a region including a moving body 140 such as a vehicle, and so on. The image processing apparatus 120 may then compress the images of the characteristic regions at degrees corresponding to the characteristic types, and compress the image of the region other than the characteristic regions, at a degree higher than the compression degrees used in compressing the images of the characteristic regions. Note that the image processing apparatus 120 stores therein a model of a three-dimensional object. The image processing apparatus 120 generates a three-dimensional model representing an object from an image of the object in a characteristic region in the captured moving image.

The image processing apparatus 120 generates characteristic region information including information identifying a characteristic region detected from a captured image and model information including information identifying the three-dimensional model. Then, the image processing apparatus 120 transmits the model information and the characteristic region information attached to the compressed moving image data, to the image processing apparatus 170 via the communication network 110.

The image processing apparatus 170 receives, from the image processing apparatus 120, the compressed moving image data to which the model information and the characteristic region information are attached. The image processing apparatus 170 expands the received compressed moving image data using the attached characteristic region information. During this process, the image processing apparatus 170 uses the model information to generate the image of the object in the characteristic region. The moving image for display generated in this way is supplied to the display apparatus 180. The display apparatus 180 displays the moving image for display supplied from the image processing apparatus 170.

In addition, the image processing apparatus 170 may record, in the image DB 175, the compressed moving image data and the model information, in association with the characteristic region information attached to the compressed moving image data. The image processing apparatus 170, upon reception of the request of the display apparatus 180, may read the compressed moving image data, the characteristic region information, and the model information from the image DB 175, and generate the moving image for display in the above-stated manner and supply it to the display apparatus 180.

Note that the characteristic region information may be text data including the position, the size, and the number of characteristic regions, as well as identification information identifying the captured image from which the characteristic regions are detected. The characteristic region information may also be the above text data provided with processing such as compression and encryption. The image processing apparatus 170 identifies a captured image satisfying various search conditions, based on the position, the size, the number of characteristic regions included in the characteristic region information. The image processing apparatus 170 may decode the identified captured image, and provide the decoded image to the display apparatus 180.

In this way, the image processing system 10 records each characteristic region in association with a moving image, and so can quickly search the moving image for a group of captured images matching a predetermined condition, to perform random access. In addition, the image processing system 10 can decode only a group of captured images matching a predetermined condition, enabling to display a partial moving image matching a predetermined condition quickly in response to a playback request.

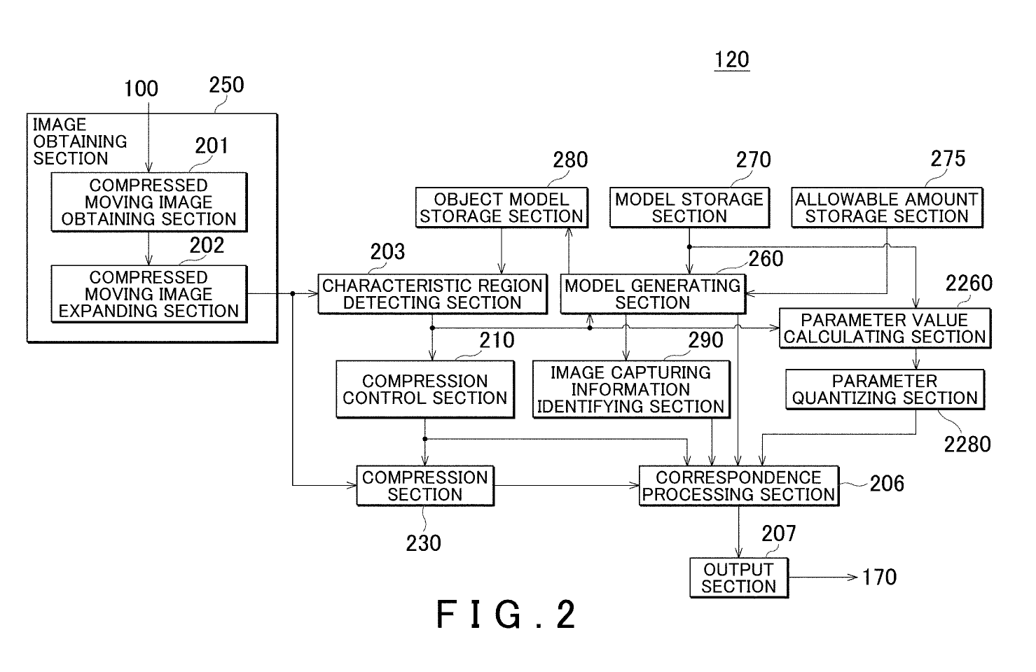

FIG. 2 shows an example of a block configuration of an image processing apparatus 120. The image processing apparatus 120 includes an image obtaining section 250, a characteristic region detecting section 203, a model storage section 270, an object model storage section 280, an allowable amount storage section 275, a model generating section 260, an image capturing information identifying section 290, a parameter value calculating section 2260, a parameter quantizing section 2280, a compression control section 210, a compression section 230, a correspondence processing section 206, and an output section 207. The image obtaining section 250 includes a compressed moving image obtaining section 201 and a compressed moving image expanding section 202.

The compressed moving image obtaining section 201 obtains the compressed moving image. Specifically, the compressed moving image obtaining section 201 obtains the encoded captured moving image data generated by the image capturing apparatus 100. The compressed moving image expanding section 202 expands the captured moving image data obtained by the compressed moving image obtaining section 201, and generates a plurality of captured images included in the captured moving image. Specifically, the compressed moving image expanding section 202 decodes the encoded captured moving image data obtained by the compressed moving image obtaining section 201, and generates the plurality of captured images included in the captured moving image. A captured image included in the captured moving image may be a frame image or a field image. Note that a captured image in the present embodiment may be an example of a moving image constituting image of the present invention. In this way, the image obtaining section 250 obtains the plurality of moving images captured by each of the plurality of image capturing apparatuses 100.

The plurality of captured images obtained by the compressed moving image expanding section 202 are supplied to the characteristic region detecting section 203 and to the compression section 230. The characteristic region detecting section 203 detects a characteristic region from a moving image including a plurality of captured images. Specifically, the characteristic region detecting section 203 detects a characteristic region from each of the plurality of captured images. Note that the above-described captured moving image may be an example of a moving image in the following explanation.

For example, the characteristic region detecting section 203 detects, as a characteristic region, an image region of a moving image, within which the image changes. Specifically, the characteristic region detecting section 203 may detect, as a characteristic region, an image region including a moving object. Note that the characteristic region detecting section 203 may detect a plurality of characteristic regions having different characteristic types from each other, from each of the plurality of captured images. Note that the type of a characteristic may be defined using a type of an object (e.g., a person, a moving body) as an index. The type of the object may be determined based on the degree of matching of the form of the objects or the color of the objects. In this way, the characteristic region detecting section 203 may detect, from a plurality of captured images, a plurality of characteristic regions respectively including different types of objects.

For example, the characteristic region detecting section 203 may extract an object that matches a predetermined form pattern at a degree of matching higher than a predetermined degree of matching, from each of the plurality of captured images, and detect the regions in the captured images that include the extracted object, as characteristic regions sharing the same characteristic type. A plurality of form patterns may be determined for a plurality of characteristic types respectively. An exemplary form pattern is a form pattern of a face of a person. Note that a plurality of face patterns may be provided for a plurality of people respectively. Accordingly, the characteristic region detecting section 203 may detect different regions including different people from each other, as different characteristic regions. Note that the characteristic region detecting section 203 may also detect, as characteristic regions, regions including a part of a person such as head of a person, hand of a person, or at least a part of a living body other than a human being, not limited to a face of a person mentioned above. Note that a living body includes certain tissue existing inside the living body, such as tumor tissue or blood vessels in the living body. The characteristic region detecting section 203 may also detect, as characteristic regions, regions including money, a card such as a cache card, a vehicle, or a number plate of a vehicle, other than a living body.

In addition to the pattern matching using a template matching, the characteristic region detecting section 203 may also perform characteristic region detection based on the learning result such as by machine learning (e.g. AdaBoost) described in Japanese Patent Application Publication No. 2007-188419. For example, the characteristic region detecting section 203 uses the image feature value extracted from the image of a predetermined subject and the image feature value extracted from the image of a subject other than the predetermined subject, to learn about the characteristic in the image feature value extracted from the image of the predetermined subject. Then, the characteristic region detecting section 203 may detect, as a characteristic region, a region from which the image feature value corresponding to the characteristic matching the learned characteristic is extracted. Accordingly, the characteristic region detecting section 203 can detect, as a characteristic region, a region including a predetermined subject.

In this way, the characteristic region detecting section 203 detects a plurality of characteristic regions from a plurality of captured images included in each of a plurality of moving images. The characteristic region detecting section 203 supplies information indicating a detected characteristic region to the compression control section 210. Information indicating a characteristic region includes coordinate information of a characteristic region indicating a position of a characteristic region, type information indicating a type of a characteristic region, and information identifying a captured moving image from which a characteristic region is detected. In this way, the characteristic region detecting section 203 detects a characteristic region in a moving image.

The compression control section 210 controls compression of a moving image performed by the compression section 230 for each characteristic region, based on the information indicating the characteristic region obtained from the characteristic region detecting section 203. Note that the compression section 230 may compress the captured image by causing to differ the degree of compression between the characteristic regions in the captured image and the region other than the characteristic regions in the captured image. For example, the compression section 230 compresses the captured image by lowering the resolution of the region other than the characteristic regions in the captured image included in the moving image. In this way, the compression section 230 compresses the image of the region other than the characteristic regions, by lowering the image quality of the image of the region other than the characteristic regions. In addition, the compression section 230 compresses each of image regions in a captured image depending on its degree of importance. Note that the concrete compression operation inside the compression section 230 is detailed later.

Note that the model storage section 270 stores a reference model that is a three-dimensional model representing an object. The model generating section 260 generates an object model that is a three-dimensional model that matches an object captured in a plurality of captured images, based on the content of the plurality of captured images of the object. The output section 207 outputs the position and the direction of an object captured in each of the plurality of captured images, in association with the difference information between the reference model and the object model, as detailed later. Specifically, the model generating section 260 generates an object model by changing a reference model. The output section 207 outputs the position and the direction of the captured object, in association with the difference information indicating the amount of change of the object model generated by the model generating section 260 from the reference model.

Note that the model storage section 270 may store a plurality of reference models. The model generating section 260 may generate an object model by changing a reference model selected from a plurality of reference models. For example, the model storage section 270 may store a plurality of reference models for each portion of an object, and the model generating section 260 may generate an object model for each portion by selecting the reference model for the portion and changing the reference model selected for the portion. Then, the output section 207 may output the position and the direction of the captured object in association with the information identifying the selected reference model and the difference information.

Note that the allowable amount storage section 275 stores the allowable range of the amount of change allowed from the reference model. The model generating section 260 may generate an object model by changing a reference model within the allowable range of the amount of change stored in the allowable amount storage section 275. The image capturing information identifying section 290 identifies the illumination condition under which the object captured in the captured image is illuminated, based on the object model and the captured image. For example, the illumination condition includes a type of illumination and a direction of illumination. In this case, the output section 207 may output the position and the direction of the captured object, in association with the difference information and the illumination condition.

Note that the model generating section 260 may generate an object model based on the plurality of captured images including an object captured in a characteristic region. The output section 207 may output the position and the direction of the object captured in the characteristic region detected from each of the plurality of captured images, in association with the difference information. In addition, the object model storage section 280 stores the object model generated by the model generating section 260. The characteristic region detecting section 203 detects, as a characteristic region, a region including an object matching the object model, from a newly captured image.

The correspondence processing section 206 associates information identifying the characteristic region detected from the captured image and the model information, with the captured image. Specifically, the correspondence processing section 206 associates the information identifying the characteristic region detected from the captured image and the model information, with a compressed moving image including the captured image as a moving image constituting image. The output section 207 outputs, to the image processing apparatus 170, the compressed moving image to which the information identifying the characteristic region and the model information are associated by the correspondence processing section 206.

In this way, the output section 207 outputs the model information and the image of the region other than the characteristic regions. More specifically, the output section 207 outputs the model information identifying the object model, and the image of the region other than the characteristic regions whose image quality is lowered by the compression section 230.

As explained above, the image processing apparatus 120 can sufficiently reduce the amount of data by expressing the image of an object in the characteristic region by the model information as well as retaining information operable to reconstruct the image of the object in the future. Moreover, the amount of data can be substantially reduced by lowering the image quality of the background region having a low degree of importance compared to the characteristic regions.

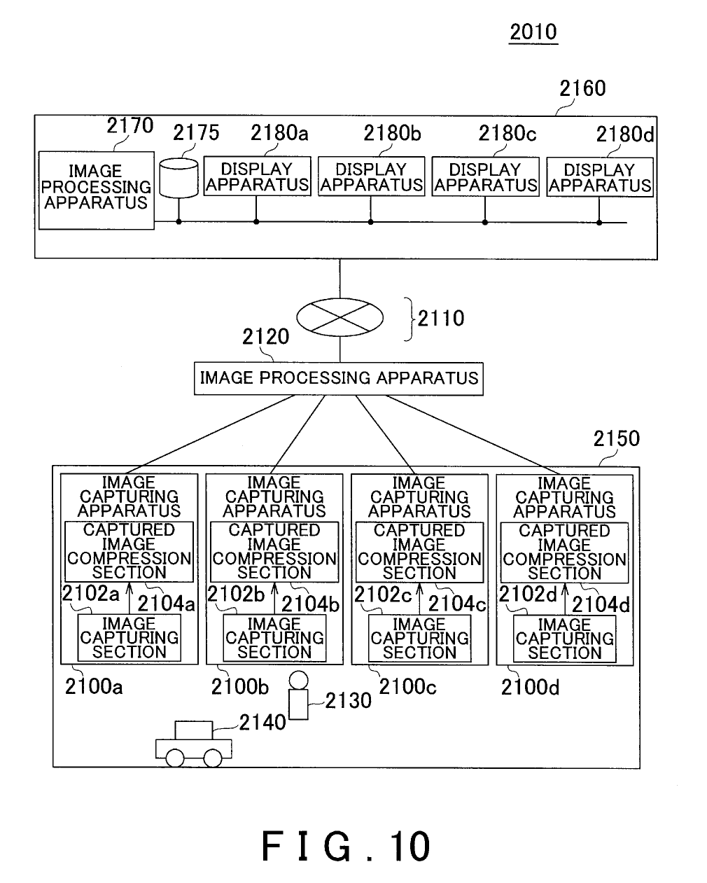

Note that the model storage section 270 may store the three-dimensional model expressing an object by a feature parameter. Specifically, the model storage section 270 may store the three-dimensional model expressing an object by a statistical feature parameter. More specifically, the model storage section 2270 may store a model expressing the form of an object by a principal component based on a principal component analysis. Note that the concrete example of the feature parameter is explained later with reference to FIG. 10 and the drawings thereafter.

The parameter value calculating section 2260 adapts the image of the object included the image of the characteristic region in the captured image to a three-dimensional model stored in the model storage section 270, thereby calculating the value of the feature parameter in the three-dimensional model expressing the object included in the image of the characteristic region. Then, the output section 207 outputs the value of the feature parameter calculated by the parameter value calculating section 2260 and the image of the region other than the characteristic regions. The output section 207 may output the value of the feature parameter calculated by the parameter value calculating section 2260 and the image of the region other than the characteristic regions whose image quality has been lowered by the compression section 230. Note that exemplary functions and operations of the parameter value calculating section 2260, the parameter quantizing section 2280, and the output section 207 are explained with reference to the drawings starting from FIG. 10.

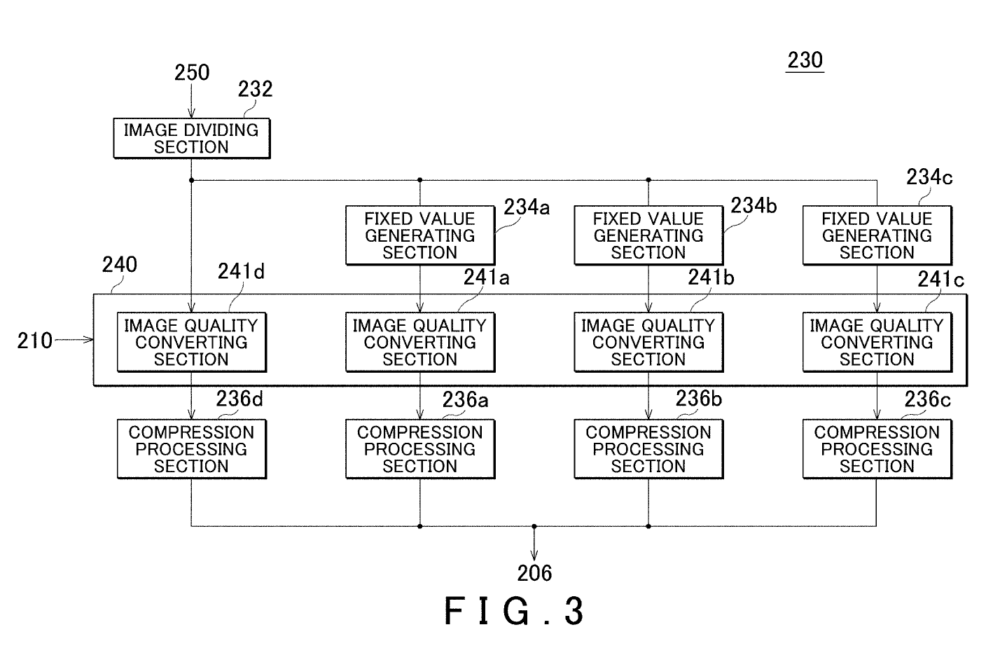

FIG. 3 shows an example of a block configuration of the compression section 230. The compression section 230 includes an image dividing section 232, a plurality of fixed value generating sections 234a-c (hereinafter occasionally collectively referred to as “fixed value generating section 234”), an image quality converting unit 240 that includes a plurality of image quality converting sections 241a-d (hereinafter collectively referred to as “image quality converting section 241”), and a plurality of compression processing sections 236a-d (hereinafter occasionally collectively referred to as “compression processing section 236”).

The image dividing section 232 obtains a plurality of captured images from the image obtaining section 250. Then, the image dividing section 232 divides characteristic regions from a background region other than the characteristic regions, in the plurality of captured images. Specifically, the image dividing section 232 divides each of a plurality of characteristic regions from a background region other than the characteristic regions, in the plurality of captured images. In this way, the image dividing section 232 divides characteristic regions from a background region in each of the plurality of captured images.

The compression processing section 236 compresses a characteristic region image that is an image of a characteristic region and a background region image that is an image of a background region at different degrees from each other. Specifically, the compression processing section 236 compresses a characteristic region moving image including a plurality of characteristic region images, and a background region moving image including a plurality of background region images at different degrees from each other.

Specifically, the image dividing section 232 divides a plurality of captured images to generate a characteristic region moving image for each of a plurality of characteristic types. The fixed value generating section 234 generates, for each characteristic region image included in a plurality of characteristic region moving images respectively generated according to characteristic types, a fixed value of a pixel value of a region other than the characteristic region corresponding to the characteristic. Specifically, the fixed value generating section 234 sets the pixel value of the region other than the characteristic regions to be a predetermined pixel value.

The image quality converting section 241 converts the image quality of an image of a characteristic region and of an image of a background region. For example, the image quality converting section 241 converts at least one of the resolution, the number of gradations, the dynamic range, or the number of included colors, for each of images of characteristic regions and an image of a background region resulting from the division. Then, the compression processing section 236 compresses the plurality of characteristic region moving images for each characteristic type. For example, the compression processing section 236 MPEG compresses the plurality of characteristic region moving images for each characteristic type.

Note that the fixed value generating sections 234a, 234b, and 234c respectively perform the fixed value processing on the characteristic region moving image of the first characteristic type, the characteristic region moving image of the second characteristic type, and the characteristic region moving image of the third characteristic type. The image quality converting sections 241a, 241b, 241c, and 241d respectively convert the image qualities of the characteristic region moving image of the first characteristic type, the characteristic region moving image of the second characteristic type, the characteristic region moving image of the third characteristic type, and the background region moving image. Then, the compression processing sections 236a, 236b, 236c, and 236d compress the characteristic region moving image of the first characteristic type, the characteristic region moving image of the second characteristic type, the characteristic region moving image of the third characteristic type, and the background region moving image.

Note that the compression processing sections 236a-c compress a characteristic region moving image at a predetermined degree according to a characteristic type. For example, the compression processing section 236 may convert characteristic region moving images into respectively different resolutions predetermined according to characteristic types, and compress the converted characteristic region moving images. When compressing the characteristic region moving images using MPEG encoding, the compression processing section 236 may compress the characteristic region moving images with respectively different quantization parameters predetermined according to characteristic types.

Note that the compression processing section 236d compresses the background region moving image. Note that the compression processing section 236d may compress a background region moving image at a degree higher than any degree adopted by the compression processing sections 236a-c. The characteristic region moving images and the background region moving image compressed by the compression processing section 236 are supplied to the correspondence processing section 206.

Since the region other than the characteristic regions has been subjected to the fixed value processing by the fixed value generating section 234, when the compression processing section 236 performs prediction coding such as MPEG encoding, the amount of difference between the image and the predicted image in the region other than the characteristic region can be substantially reduced. Therefore, the compression ratio of the characteristic region moving image can be substantially enhanced.

In this way, by reducing the image quality of the captured image, the compression section 230 generates an image to be an input image to the image processing apparatus 170. Specifically, the compression section 230 generates an image to be an input image to the image processing apparatus 170, such as by reducing the resolution, the number of gradations, and the number of used colors of the captured image. In addition, the compression section 230 may for example generate an image to be an input image to the image processing apparatus 170, by lowering the spatial frequency component in the captured image.

Note that in this drawing, each of the plurality of compression processing sections 236 included in the compression section 230 compresses the images of the plurality of characteristic regions and the image of the background region. However, in another embodiment, the compression section 230 may include a single compression processing section 236, and this single compression processing section 236 may compress the images of the plurality of characteristic regions and the image of the background region at respectively different degrees. For example, an arrangement is possible in which the images of the plurality of characteristic regions and the image of the background region are sequentially supplied in time division to the single compression processing section 236, and the single compression processing section 236 sequentially compresses the images of the plurality of characteristic regions and the image of the background region at respectively different degrees.

Alternatively, a single compression processing section 236 may compress the images of the plurality of characteristic regions and the image of the background region at different degrees from each other, by respectively quantizing the image information of the plurality of characteristic regions and the image information of the background region at different quantization factors from each other. An arrangement is also possible in which the images resulting from converting the images of the plurality of characteristic regions and the image of the background region into respectively different image qualities are supplied to the single compression processing section 236, and the single compression processing section 236 compresses the images of the plurality of characteristic regions and the image of the background region respectively. Note that this image quality conversion may be performed by a single image quality converting unit 240. Also in such an embodiment described above in which a single compression processing section 236 performs quantization using different quantization factors for each of regions and the images converted into different image qualities for each of regions are compressed by a single compression processing section 236, the single compression processing section 236 may compress a single image, or may compress the images divided by the image dividing section 232 respectively as in the present drawing. Note that when a single compression processing section 236 compresses a single image, the dividing processing by the image dividing section 232 and the fixed value processing by the fixed value generating section 234 are unnecessary, and so the compression section 230 does not have to include any image dividing section 232 or fixed value generating section 234.

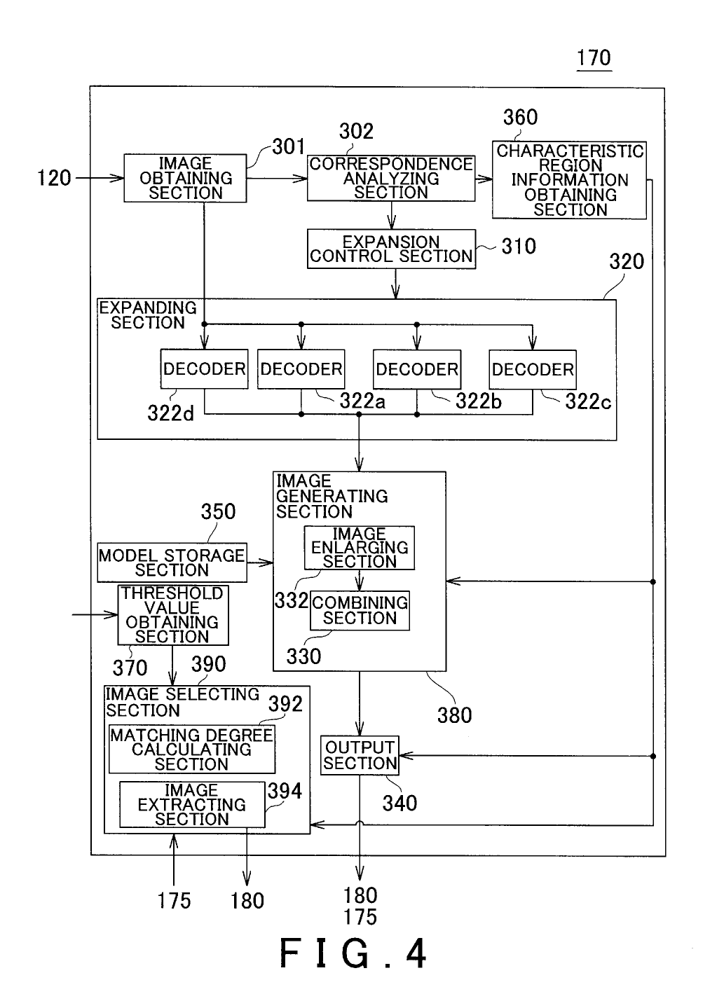

FIG. 4 shows an example of a block configuration of an image processing apparatus 170. The image processing apparatus 170 includes an image obtaining section 301, a correspondence analyzing section 302, an expansion control section 310, an expanding section 320, an image selecting section 390, an image generating section 380, a characteristic region information obtaining section 360, a model storage section 350, a threshold value obtaining section 370, and an output section 340. The image generating section 380 includes an enlarging section 332 and a combining section 330. In addition, the image selecting section 390 includes a matching degree calculating section 392 and an image extracting section 394.

The image obtaining section 301 obtains a compressed moving image compressed by the compression section 230. Specifically, the image obtaining section 301 obtains a compressed moving image including a plurality of characteristic region moving images and a background region moving image. More specifically, the image obtaining section 301 obtains a compressed moving image to which attached are characteristic region information, model information, information indicating a position and a direction of an object.

The correspondence analyzing section 302 then separates the moving image data obtained by the image obtaining section 301, into a plurality of characteristic region moving images and a background region moving image, characteristic region information, and model information, and supplies the plurality of characteristic region moving images and the background region moving image to the expanding section 320. In addition, the correspondence analyzing section 302 supplies the positions of the characteristic regions and the characteristic types to the expansion control section 310 and the characteristic region information obtaining section 360. In addition, the correspondence analyzing section 302 supplies the model information and the information indicating the position and the direction of the object to the characteristic region information obtaining section 360. In this way, the characteristic region information obtaining section 360 can obtain the information indicating each characteristic region in each of a plurality of captured images (i.e., information indicating the position of each characteristic region), the model information, and the information indicating the position and the direction of the object. The characteristic region information obtaining section 360 supplies, to the image generating section 380, the information indicating the position of the characteristic region, the model information, and the information indicating the position and the direction of the object, to the image generating section 380.

The expansion control section 310 controls the expanding processing by the expanding section 320, according to the position of the characteristic region and the characteristic type obtained from the correspondence analyzing section 302. For example, the expansion control section 310 controls the expanding section 320 to expand each region of a moving image represented by the compressed moving image, according to a compression method adopted by the compression section 230 in compressing each region of the moving image according to the position of the characteristic region and the characteristic type.

The following explains the operation of each constituting element of the expanding section 320. The expanding section 320 includes a plurality of decoders 322a-d (hereinafter collectively referred to as “decoder 322”). The decoder 322 decodes one of the plurality of characteristic region moving images and the background region moving image, which have been encoded. Specifically, the decoders 322a, 322b, 322c, and 322d respectively decode the first, second, third characteristic region moving images and a background region moving image. The expanding section 320 supplies the first, second, third characteristic region moving images and the background region moving image, which have been decoded, to the image generating section 380.

The image generating section 380 generates a single moving image for display based on the first, second, third characteristic region moving images, the background region moving image, and the characteristic region information. The output section 340 then outputs the characteristic region information obtained from the correspondence analyzing section 302 and the moving image for display to the display apparatus 180 or to the image DB 175. Note that the image DB 175 may record, in a nonvolatile recording medium such as a hard disk, the position, the characteristic type, and the number of characteristic region(s) indicated by the characteristic region information, in association with information identifying the captured image included in the moving image for display.

The model storage section 350 stores the model that is the same as the model stored in the model storage section 270. The image generating section 380 generates a two dimensional image of an object included in a characteristic region, by projecting, into a two dimensional space, a three-dimensional object model generated using the model stored in the model storage section 350, the difference information outputted from the output section 207, the position of the object, and the direction of the object.

Note that the characteristic region information obtaining section 360 may obtain the type of the object, the direction of the object, and the illumination condition outputted by the output section 207 in association with the compressed moving image. The image generating section 380 may generate a two dimensional image of an object by projecting, into a two dimensional space, the three-dimensional object model generated according to the type of the object, the direction of the object, and the illumination condition.

The image enlarging section 332 enlarges the image of the region other than the characteristic region. The combining section 330 combines the two dimensional image and the image of the enlarged region other than the characteristic region. The output section 340 outputs the image including the two dimensional image and the image other than the characteristic region. Note that the output section 340 may record, in the image DB 175, the image resulting from the combining processing in association with the difference information between the object model and the reference model. In this way, the image DB 175 stores the plurality of captured images in association with the difference information between the object model and the reference model matching each of the objects included in the plurality of captured images. Specifically, the image DB 175 stores the plurality of captured images in association with the difference information indicating the amount of change that is a change of the object model generated by the model generating section 260 from the reference model.

The image DB 175 may store the plurality of captured images in association with the model identification information that is information identifying a selected reference model and the difference information. Then, the image selecting section 390 selects the captured image stored in the image DB 175 in association with the model identification information indicating the same model as the model identification identifying the reference model selected in generating the object model matching the object included in a newly captured image, as well as the difference information matching the difference information between the object model matching the object included in the newly captured image and the reference model at a degree of matching that is higher than a predetermined value. Note that the threshold value obtaining section 370 obtains from outside of the image processing apparatus 170, the threshold value for the degree of matching for the difference information. The image selecting section may select the captured image stored in the image DB 175 in association with the difference information that matches the difference information between the object model matching the object included in the newly captured image and the reference model at a higher degree of matching than the threshold value obtained by the threshold value obtaining section 370.

Specifically, the matching degree calculating section 392 calculates the matching degree between each of pieces of difference information stored in the image DB 175 and the difference information between the object model matching the object included in the newly captured image and the reference model, for each portion. Then, the image extracting section 394 extracts the captured image stored in the image DB 175 in association with a set of pieces of difference information whose summation value of degree of matching calculated by the matching degree calculating section 392 is higher than a predetermined value.

In this way, the image selecting section 390 selects the captured image stored in the image DB 175 in association with the difference information matching the difference information between the object model matching the object included in the newly captured image and the reference model at a degree of matching that is higher than a predetermined value. By conducting search based on the difference information in this way, the image processing system 10 can quickly searches for an image.

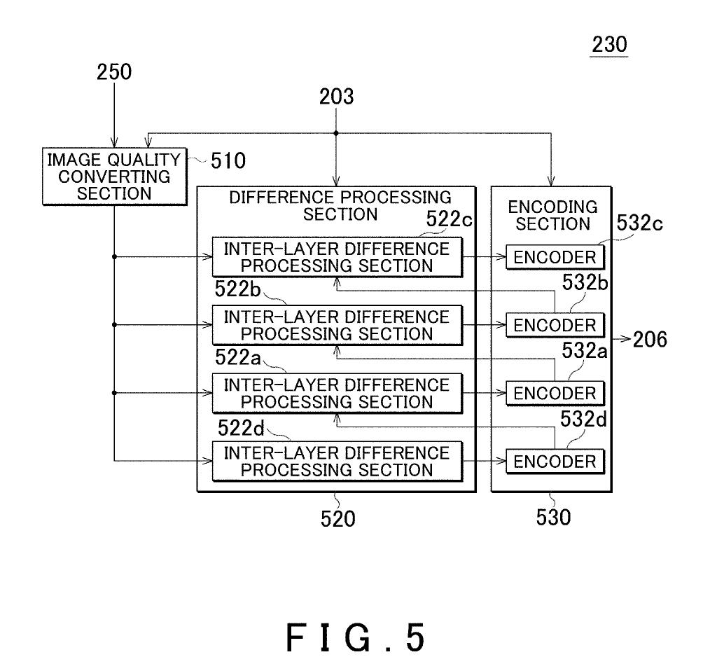

FIG. 5 shows an example of another block configuration of the compression section 230. The compression section 230 in the present configuration compresses a plurality of captured images by means of encoding processing that is spatio scalable according to the characteristic type.

The compression section 230 in the present configuration includes an image quality converting section 510, a difference processing section 520, and an encoding section 530. The difference processing section 520 includes a plurality of inter-layer difference processing sections 522a-d (hereinafter collectively referred to as “inter-layer difference processing section 522”). The encoding section 530 includes a plurality of encoders 532a-d (hereinafter collectively referred to as “encoder 532”).

The image quality converting section 510 obtains a plurality of captured images from the image obtaining section 250. In addition, the image quality converting section 510 obtains information identifying the characteristic region detected by the characteristic region detecting section 203 and information identifying the characteristic type of the characteristic region. The image quality converting section 510 then generates the captured images in number corresponding to the number of characteristic types of the characteristic regions, by copying the captured images. The image quality converting section 510 converts the generated captured images into images of resolution according to the respective characteristic types.

For example, the image quality converting section 510 generates a captured image converted into resolution according to a background region (hereinafter referred to as “low resolution image”), a captured image converted into first resolution according to a first characteristic type (hereinafter referred to as “first resolution image”), a captured image converted into second resolution according to a second characteristic type (hereinafter referred to as “second resolution image”), and a captured image converted into third resolution according to a third characteristic type (hereinafter referred to as “third resolution image”). Here, the first resolution image has a higher resolution than the resolution of the low resolution image, and the second resolution image has a higher resolution than the resolution of the first resolution image, and the third resolution image has a higher resolution than the resolution of the second resolution image.

The image quality converting section 510 supplies the low resolution image, the first resolution image, the second resolution image, and the third resolution image, respectively to the inter-layer difference processing section 522d, the inter-layer difference processing section 522a, the inter-layer difference processing section 522b, and the inter-layer difference processing section 522c. Note that the image quality converting section 510 supplies a moving image to each of the inter-layer difference processing sections 522 as a result of performing the image quality converting processing to each of the plurality of captured images.

Note that the image quality converting section 510 may convert the frame rate of the moving image supplied to each of the inter-layer difference processing sections 522 according to the characteristic type of the characteristic region. For example, the image quality converting section 510 may supply, to the inter-layer difference processing section 522d, the moving image having a frame rate lower than the frame rate of the moving image supplied to the inter-layer difference processing section 522a. In addition, the image quality converting section 510 may supply, to the inter-layer difference processing section 522a, the moving image having a frame rate lower than the frame rate of the moving image supplied to the inter-layer difference processing section 522b, and may supply, to the inter-layer difference processing section 522b, the moving image having a frame rate lower than the frame rate of the moving image supplied to the inter-layer difference processing section 522c. Note that the image quality converting section 510 may convert the frame rate of the moving image supplied to the inter-layer difference processing section 522, by thinning the captured images according to the characteristic type of the characteristic region. Note that the image converting section 510 may perform the similar image quality conversion to the image quality converting section 241 explained with reference to FIG. 3.

The inter-layer difference processing section 522d and the encoder 532d perform prediction coding on the background region moving image including a plurality of low resolution images. Specifically, the inter-layer difference processing section 522 generates a differential image representing a difference from the predicted image generated from the other low resolution images. Then, the encoder 532d quantizes the conversion factor obtained by converting the differential image into spatial frequency component, and encodes the quantized conversion factor using entropy coding or the like. Note that such prediction coding processing may be performed for each partial region of a low resolution image.

In addition, the inter-layer difference processing section 522a performs prediction coding on the first characteristic region moving image including a plurality of first resolution images supplied from the image quality converting section 510. Likewise, the inter-layer difference processing section 522b and the inter-layer difference processing section 522c respectively perform prediction coding on the second characteristic region moving image including a plurality of second resolution images and on the third characteristic region moving image including a plurality of third resolution images. The following explains the concrete operation performed by the inter-layer difference processing section 522a and the encoder 532a.

The inter-layer difference processing section 522a decodes the first resolution image having been encoded by the encoder 532d, and enlarges the decoded image to an image having a same resolution as the first resolution. Then, the inter-layer difference processing section 522a generates a differential image representing a difference between the enlarged image and the low resolution image. During this operation, the inter-layer difference processing section 522a sets the differential value in the background region to be 0. Then, the encoder 532a encodes the differential image just as the encoder 532d has done. Note that the encoding processing may be performed by the inter-layer difference processing section 522a and the encoder 532a for each partial region of the first resolution image.

When encoding the first resolution image, the inter-layer difference processing section 522a compares the amount of encoding predicted to result by encoding the differential image representing the difference from the low resolution image and the amount of encoding predicted to result by encoding the differential image representing the difference from the predicted image generated from the other first resolution image. When the latter amount of encoding is smaller than the former, the inter-layer difference processing section 522a generates the differential image representing the difference from the predicted image generated from the other first resolution image. When the encoding amount of the first resolution image is predicted to be smaller as it is without taking any difference with the low resolution image or with the predicted image, the inter-layer difference processing section 522a does not have to calculate the difference from the low resolution image or the predicted image.

Note that the inter-layer difference processing section 522a does not have to set the differential value in the background region to be 0. In this case, the encoder 532a may set the data after encoding with respect to the information on difference in the region (hereinafter occasionally referred to as “non-characteristic region”) other than the characteristic regions to be 0. For example, the encoder 532a may set the conversion factor after converting to the frequency component to be 0. When the inter-layer difference processing section 522d has performed prediction coding, the motion vector information is supplied to the inter-layer difference processing section 522a. The inter-layer difference processing section 522a may calculate the motion vector for a predicted image, using the motion vector information supplied from the inter-layer difference processing section 522d.

Note that the operation performed by the inter-layer difference processing section 522b and the encoder 532b is substantially the same as the operation performed by the inter-layer difference processing section 522a and the encoder 532a, except that the second resolution image is encoded, and when the second resolution image is encoded, the difference from the first resolution image after encoding by the encoder 532a may be occasionally calculated, and so is not explained below. Likewise, the operation performed by the inter-layer difference processing section 522c and the encoder 532c is substantially the same as the operation performed by the inter-layer difference processing section 522a and the encoder 532a, except that the third resolution image is encoded, and when the third resolution image is encoded, the difference from the second resolution image after encoding by the encoder 532b may be occasionally calculated, and so is not explained below.

As explained above, the image quality converting section 510 generates, from each of the plurality of captured images, a low image quality image and a characteristic region image having a higher image quality than the low image quality image at least in the characteristic region. The difference processing section 520 generates a characteristic region differential image being a differential image representing a difference between the image of the characteristic region in the characteristic region image and the image of the characteristic region in the low image quality image. Then, the encoding section 530 encodes the characteristic region differential image and the low image quality image respectively.

The image quality converting section 510 also generates low image quality images resulting from lowering the resolution of the plurality of captured images, and the difference processing section 520 generates a characteristic region differential image representing a difference between the image of the characteristic region in the characteristic region image and the image resulting from enlarging the image of the characteristic region in the low image quality image. In addition, the difference processing section 520 generates a characteristic region differential image having a characteristic region and a non-characteristic region, where the characteristic region has a spatial frequency component corresponding to a difference between the characteristic region image and the enlarged image converted into a spatial frequency region, and an amount of data for the spatial frequency component is reduced in the non-characteristic region.

As explained above, the compression section 230 can perform hierarchical encoding by encoding the difference between the plurality of inter-layer images having different resolutions from each other. As can be understood, a part of the compression method adopted by the compression section 230 in the present configuration includes the compression method according to H.264/SVC. Note that to expand such a hierarchically compressed moving image, the image processing apparatus 170 can generate a captured image having an original resolution by decoding the moving image data of each layer and adding the decoded captured image in the layer for which the difference was taken in the region for which encoding was performed using the inter-layer difference.

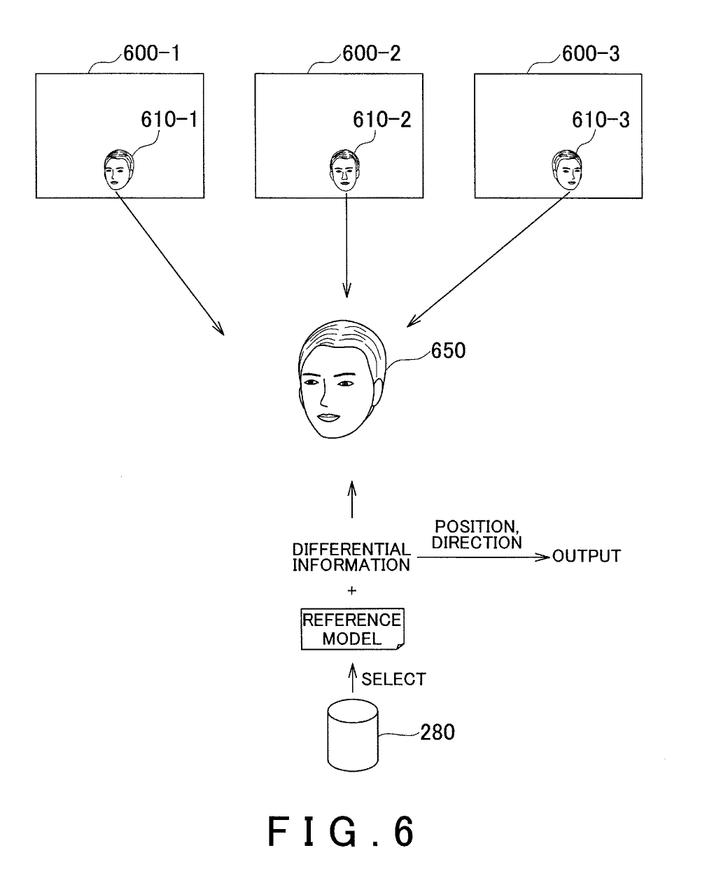

FIG. 6 shows exemplary processing performed by the image processing apparatus 120. The characteristic region detecting section 203 detects head regions 610-1-610-3, which are an example of a characteristic region, from captured images 600-1-600-3 (hereinafter collectively referred to as “captured image 600”). The model generating section 260 selects among the head regions 610-1-610-3 in different directions from each other, and generates a three-dimensional object model 650 based on the content of the image of the selected head region 610.

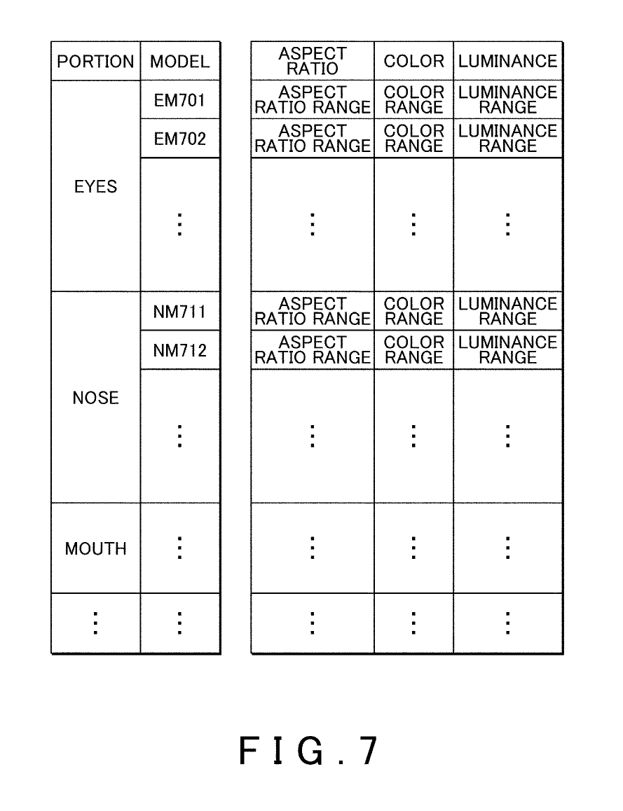

During this operation, the model generating section 260 generates the object model 650 by correcting the reference model stored in the model storage section 270. Note that an exemplary method used by the model generating section 260 for generating an object model by correcting the reference model is detailed later with reference to FIG. 7.

The output section 207 transmits, to the image processing apparatus 170, the difference information between the generated object model and the reference model. On the other hand, the output section 207 transmits the position and the direction of the object, as information to generate a two dimensional image of an object from an object model, in association with each of the captured images 600. An example of the position and the direction of the object is a positional relation between an object model and a viewing location. Here, the viewing location may be a viewing location at which a two dimensional image of an object (e.g., the image of the head region 610) can be viewed when projecting an object model in a two dimensional space.

Note that the output section 207 may transmit, to the image processing apparatus 170, a piece of difference information in association with a plurality of captured images 600. Accordingly, the amount of data transmitted from the image processing apparatus 120 to the image processing apparatus 170 can be reduced. Note that an example of the difference information is the amount of change from a reference model as described above.

FIG. 7 shows, in a table format, an example of data stored in a model storage section 270 and an allowable amount storage section 275. The model storage section 270 stores a reference model for each portion. For example, the models storage section 270 stores a plurality of reference models EM701, EM702, . . . representing eyes and a plurality of reference models NM701, NM702, . . . representing a nose.

The allowable amount storage section 275 stores allowable change ranges respectively for reference models including the reference models EM701, EM702, NM701, NM702 . . . . Note that the allowable change ranges may include an aspect ratio range as an example of an allowable change range related to a form, and a color difference range and a luminance range as an example of allowable change range related to color information.

The model generating section 260 selects a reference model from the model storage section 270 for each portion, based on the image of the head region 610. For example, the model generating section 260 selects, for each portion included in the head region 610, a reference model whose form matches the image of each portion at a degree of matching higher than a predetermined value.

Then, the model generating section 260 compares, with the image of each portion, an image obtained by changing the aspect ratio of a reference model within the range of the aspect ratio stored in the allowable amount storage section 275, to identify the aspect ratio matching, in form, the image of each portion at the highest degree. In addition, the model generating section 260 compares, with the image of each portion, an image obtained by changing a color difference and luminance from those of a reference model, to identify the color difference information and the luminance information matching, in color, the image of each portion at the highest degree. Note that some examples of the amount of change are the aspect ratio, the color difference information, and the luminance information. In this way, the model generating section 260 generates an object model represented by a reference model and difference information (e.g., amount of change).

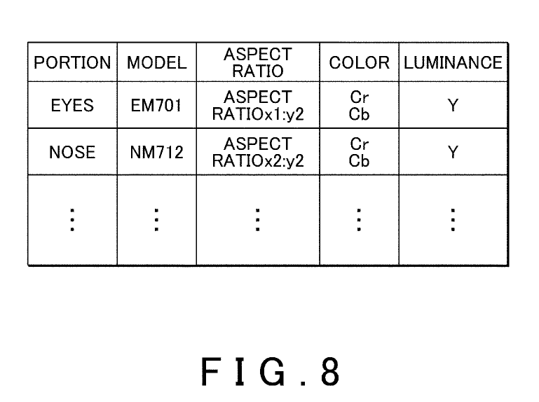

FIG. 8 shows, in a table format, an example of data stored in an image DB 175 in association with a captured image 600. The image processing apparatus 170 causes the image DB 175 to store the information identifying the model obtained form the image processing apparatus 120, the aspect ratio, the color difference information, and the luminance information, in association with a plurality of captured images 600 including the head region 610. Note that the image processing apparatus 170 causes the image DB 175 to store, for each portion, a set of the information identifying the model, the aspect ratio, the color difference information, and the luminance information.

When obtaining information identifying a model representing an object of a characteristic region detected from a newly captured image obtained by the image obtaining section 301, as well as a set of aspect ratio, color difference information, and luminance information, which is a set of difference information with respect to the model, the matching degree calculating section 392 reads, from the image DB 175, the set of aspect ratio, color difference information, and luminance information which is stored in association with the information identifying the model. Then, the matching degree calculating section 392 compares the read set of aspect ratio, color difference information, and luminance information to the set of difference information for the newly captured image, to calculate the degree of matching therebetween.

Then, the image extracting section 394 obtains the summation of the degrees of matching for each portion calculated by the matching degree calculating section 392, to allow extraction of the captured image stored in the image DB 175 in association with the set pieces of difference information whose summation value of degree of matching is higher than a predetermined value. In this way, the image selecting section 390 can select a captured image including a similar object based on numerical values such as the information identifying a model, the aspect ratio, the color difference information, and the luminance information. Therefore, the image processing system 10 can quickly select an image than in a case of selecting an image based on its content.

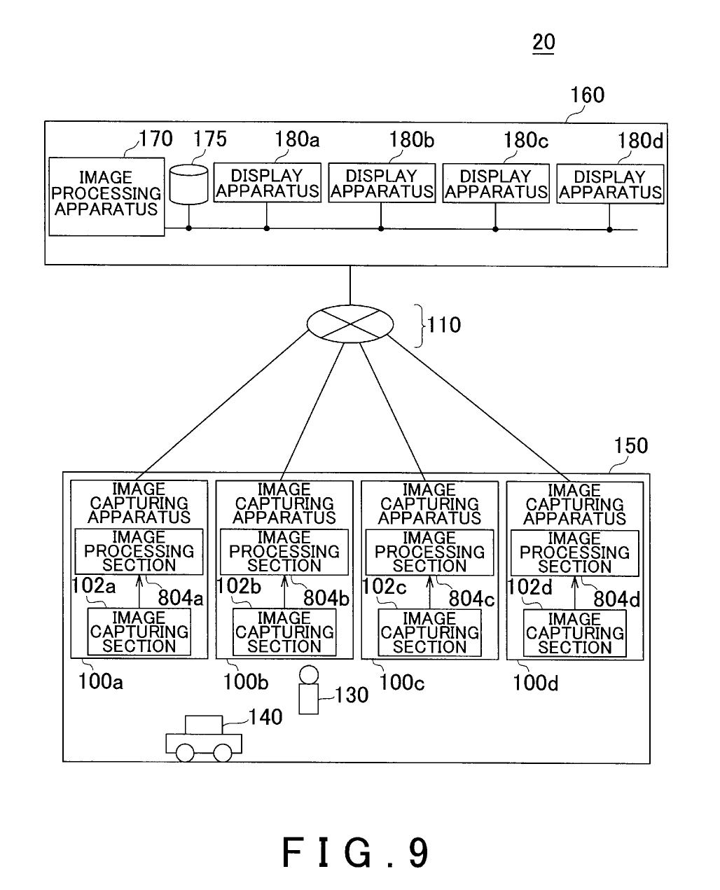

FIG. 9 shows an example of an image processing system 20 according to another embodiment. The configuration of the image processing system 20 in the present embodiment is the same as the configuration of the image processing system 10 of FIG. 1, except that the image capturing apparatuses 100a-d respectively include image processing sections 804a-d (hereinafter collectively referred to as “image processing section 804”).

The image processing section 804 includes all the constituting element of the image processing apparatus 120 except for the image obtaining section 250. The function and operation of each constituting element of the image processing section 804 may be substantially the same as the function and operation of each constituting element of the image processing apparatus 120, except that each constituting element of the image processing section 804 processes the captured moving image captured by the image capturing section 102 instead of processing the captured moving image obtained by expanding processing performed by the compressed moving image expanding section 202. The image processing system 20 having the stated configuration can also obtain substantially the same effect as the effect obtained by the image processing system 10 explained above with reference to FIG. 1 through FIG. 8.

Note that the image processing section 804 may obtain, from the image capturing section 102, a captured moving image including a plurality of captured images represented in RAW format, and compress the plurality of captured images represented in RAW format in the obtained captured moving image, as they are in the RAW format. For example, the image processing section 804 may compress the image of the region to be compressed without using the three-dimensional model explained above with reference to FIG. 1 through FIG. 8, in the original RAW format. Note that the image processing section 804 may detect one or more characteristic regions from a plurality of captured images represented in RAW format. In addition, the image processing section 804 may compress a captured moving image including a plurality of compressed captured images represented in RAW format. The image processing section 804 can perform compression using a compression method explained above as the operation of the image processing apparatus 120 with reference to FIG. 1 through FIG. 8. The image processing apparatus 170 can obtain the plurality of captured images represented in RAW format, by expanding the moving image obtained from the image processing section 804. The image processing apparatus 170 enlarges, for each region, the plurality of captured images represented in RAW format obtained by expansion, and performs synchronization processing for each region. During this operation, the image processing apparatus 170 may perform higher definition synchronization processing on the characteristic regions than in the region other than the characteristic region.

Note that the image processing apparatus 170 may perform super resolution processing on the captured images obtained by the synchronization processing. The super resolution processing adopted by the image processing apparatus 170 may include super resolution processing based on the principal component analysis described in Japanese Patent Application Publication No. 2006-350498 and super resolution processing based on the movement of the subject described in Japanese Patent Application Publication No. 2004-88615.

The image processing apparatus 170 may perform the super resolution processing for each object included in the characteristic region. When the characteristic region includes a facial image of a person, the image processing apparatus 170 may perform the super resolution processing for each facial portion (e.g., eyes, nose, and mouth) as an example of information identifying the type of an object. In this case, the image processing apparatus 170 stores the learning data such as a model as disclosed in Japanese Patent Application Publication No. 2006-350498, for each facial portion (e.g., eyes, nose, and mouth). Then, by using the learning data selected for each facial portion included in the characteristic region, the image processing apparatus 170 may perform the super resolution processing on the image of each facial portion.

In this way, the image processing apparatus 170 can reconstruct the image of a characteristic region using a principal component analysis (PCA). Note that examples of the image reconstruction method by means of the image processing apparatus 170 and the learning method thereof include, other than the learning and image reconstruction by means of principal component analysis (PCA), locality preserving projection (LPP), linear discriminant analysis (LDA), independent component analysis (ICA), multidimensional scaling (MDS), support vector machine (SVM) (support vector regression), neutral network, Hidden Markov Model (HMM), Bayes estimator, Maximum a posteriori, Iterative Back Projection Method, Wavelet Conversion, locally linear embedding (LLE), Markov random field (MRF), and so on.

The learning data may include, other than the model described in Japanese Patent Application Publication No. 2006-350498, a low frequency component and a high frequency component of the image of the object respectively extracted from a multiple sample images of the object. Here, for each type of the plurality of objects, the low frequency component of the image of the object can be clustered into a plurality of clusters, by means of K-means or the like. In addition, a representative low frequency component (e.g., barycenter value) can be determined for each cluster.

The image processing apparatus 170 extracts the low frequency component from the image of the object included in the characteristic region in the captured image. The image processing apparatus 170 identifies the cluster whose value matching the extracted low frequency component is determined as the representative low frequency component. The image processing apparatus 170 identifies the cluster of the high frequency component associated with the low frequency component included in the identified cluster. In this way, the image processing apparatus 170 can identify the cluster of the high frequency component correlated to the low frequency component extracted from the object included in the captured image. The image processing apparatus 170 can convert the image of the object into higher image quality, using a high frequency component representative of the identified cluster of high frequency component. For example, the image processing apparatus 170 may add, to the image of the object, the high frequency component selected for each object with a weight corresponding to the distance up to the processing target position on the face from the center of each object. Here, the representative high frequency component may be generated by closed-loop learning. In this way, the image processing apparatus 170 can sometimes render the image of the object into high image quality with higher accuracy, since it selects desirable learning data from among the learning data generated by performing learning according to each object.

An image of an object is represented by a principal component vector and a weighting factor, in the super-resolution processing based on the principal component analysis as described in Japanese Patent Application Publication No. 2006-350498. The data amount of these weighting factor and principal component vector is substantially smaller than the amount of the pixel data included in the image of the object itself. With this in view, the image processing section 804 can calculate the weighting factor from the image of the object included in the characteristic region, in compression of the image of the characteristic region in the plurality of captured images obtained from the image capturing section 102 without using the three-dimensional model explained with reference to FIG. 1 through FIG. 8. That is, the image processing section 804 can compress the image of the object included in the characteristic region, by representing the image by the principal component vector and the weighting factor. The image processing section 804 then can transmit the principal component vector and the weighting factor to the image processing apparatus 170. The image processing apparatus 170 can use the principal component vector and the weighting factor obtained from the image processing section 804, to reconstruct the image of the object included in the characteristic region. Here, needless to say, the image processing section 804 can compress the image of the object included in the characteristic region, by using the model representing the object using various characteristic parameters, other than the model based on the principal component analysis as described in Japanese Patent Application Publication No. 2006-350498. Note that also in the configuration of the image processing system 10 explained with reference to FIG. 1 through FIG. 8, the image processing apparatus 17000 may also perform the above-explained super resolution processing

FIG. 10 shows an example of an image processing system 2010 according to an embodiment. The image processing system 2010 can function as a monitoring system as described below.

The image processing system 2010 includes a plurality of image capturing apparatuses 2100a-d (hereinafter collectively referred to as “image capturing apparatus 2100”) for capturing an image of a monitored space 2150, an image processing apparatus 2120 for processing the images captured by the image capturing apparatus 2100, a communication network 2110, an image processing apparatus 2170, an image DB 2175, and a plurality of display apparatuses 2180a-d (hereinafter collectively referred to as “display apparatus 2180”). The image processing apparatus 2170 and the display apparatus 2180 are provided in a space 2160 different from the monitored space 2150.

The image capturing apparatus 2100a includes an image capturing section 2102a and a captured image compression section 2104a. The image capturing section 2102a captures a plurality of images by successively capturing the monitored space 2150. Note that the images captured by the image capturing section 2102a may be images in RAW format. The captured image compression section 2104a generates captured moving image data by synchronizing the captured images in RAW format captured by the image capturing section 2102a, and compressing a captured moving image including the plurality of captured images obtained by the synchronization, using MPEG encoding or the like. In this way, the image capturing apparatus 2100a generates captured moving image data by encoding the captured moving image obtained by capturing the image of the monitored space 2150. The image capturing apparatus 2100a outputs the captured moving image data to the image processing apparatus 2120.

Since the image capturing apparatuses 2100b, 2100c, and 2100d respectively have the same configuration as that of the image capturing apparatus 2100a, the explanation of each constituting element of the image capturing apparatuses 2100b, 2100c, and 2100d is not provided in the following. The image processing apparatus 2120 obtains, from each image capturing apparatus 2100, the captured moving image data generated by each image capturing apparatus 2100.

Then, the image processing apparatus 2120 obtains a captured moving image by decoding the captured moving image data obtained from the image capturing apparatus 2100. The image processing apparatus 2120 detects, from each of a plurality of captured images included in the obtained captured moving image, a plurality of characteristic regions having different characteristic types, such as a region including a person 2130, a region including a moving body 2140 such as a vehicle, and so on. The image processing apparatus 2120 may then compress the images of the characteristic regions at degrees corresponding to the characteristic types, and compress the image other than the characteristic region, at a degree higher than the compression degrees used in compressing the images of the characteristic regions.

Note that the image processing apparatus 2120 stores therein a mathematical model expressing an object using a feature parameter. The image processing apparatus 2120 adapts the image of an object included in the characteristic region to the mathematical model, to calculate the value of the feature parameter expressing the image of the object.

The image processing apparatus 2120 generates characteristic region information including information identifying a characteristic region detected from a captured image. Then, the image processing apparatus 2120 transmits the value of the feature parameter and the characteristic region information attached to the compressed moving image data, to the image processing apparatus 2170 via the communication network 2110.

The image processing apparatus 2170 receives, from the image processing apparatus 2120, the compressed moving image data to which the value of the feature parameter and the characteristic region information are attached. The image processing apparatus 2170 expands the received compressed moving image data using the attached characteristic region information. During this process, the image processing apparatus 2170 generates the image of the object in the characteristic region by changing the model with the value of the feature parameter using the expanded image of the characteristic region. The moving image for display generated in this way is supplied to the display apparatus 2180. The display apparatus 2180 displays the moving image for display supplied from the image processing apparatus 2170.

In addition, the image processing apparatus 2170 may record, in the image DB 2175, the compressed moving image data and the feature parameter, in association with the characteristic region information attached to the compressed moving image data. The image processing apparatus 2170, upon reception of the request of the display apparatus 2180, may read the compressed moving image data, the characteristic region information, and the value of the feature parameter from the image DB 2175, and generate the moving image for display in the above-stated manner and supply it to the display apparatus 2180.

Note that the characteristic region information may be text data including the position, the size, and the number of characteristic regions, as well as identification information identifying the captured image from which the characteristic regions are detected. The characteristic region information may also be the above text data provided with processing such as compression and encryption. The image processing apparatus 2170 identifies a captured image satisfying various search conditions, based on the position, the size, the number of characteristic regions included in the characteristic region information. The image processing apparatus 2170 may decode the identified captured image, and provide the decoded image to the display apparatus 2180.

In this way, the image processing system 2010 records each characteristic region in association with a moving image, and so can quickly search the moving image for a group of captured images matching a predetermined condition, to perform random access. In addition, the image processing system 2010 can decode only a group of captured images matching a predetermined condition, enabling to display a partial moving image matching a predetermined condition quickly in response to a playback request.

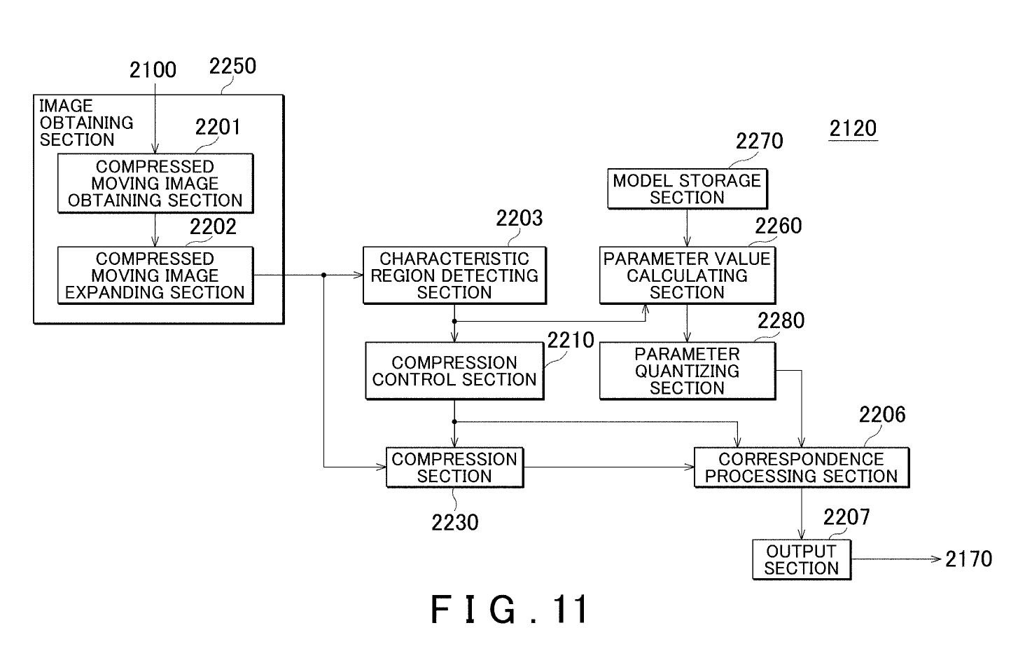

FIG. 11 shows an example of a block configuration of an image processing apparatus 2120. The image processing apparatus 2120 includes an image obtaining section 2250, a characteristic region detecting section 2203, a model storage section 2270, a parameter value calculating section 2260, a parameter quantizing section 2280, a compression control section 2210, a compression section 2230, a correspondence processing section 2206, and an output section 2207. The image obtaining section 2250 includes a compressed moving image obtaining section 2201 and a compressed moving image expanding section 2202.

The compressed moving image obtaining section 2201 obtains the compressed moving image. Specifically, the compressed moving image obtaining section 2201 obtains the encoded captured moving image data generated by the image capturing apparatus 2100. The compressed moving image expanding section 2202 expands the captured moving image data obtained by the compressed moving image obtaining section 2201, and generates a plurality of captured images included in the captured moving image Specifically, the compressed moving image expanding section 2202 decodes the encoded captured moving image data obtained by the compressed moving image obtaining section 2201, and generates the plurality of captured images included in the captured moving image. A captured image included in the captured moving image may be a frame image or a field image. Note that a captured image in the present embodiment may be an example of a moving image constituting image of the present invention. In this way, the image obtaining section 2250 obtains the plurality of moving images captured by each of the plurality of image capturing apparatuses 2100.

The plurality of captured images obtained by the compressed moving image expanding section 2202 are supplied to the characteristic region detecting section 2203 and to the compression section 2230. The characteristic region detecting section 2203 detects a characteristic region from a moving image including a plurality of captured images. Specifically, the characteristic region detecting section 2203 detects a characteristic region from each of the plurality of captured images. Note that the above-described captured moving image may be an example of a moving image in the following explanation.

For example, the characteristic region detecting section 2203 detects, as a characteristic region, an image region of a moving image, within which the content of the image changes. Specifically, the characteristic region detecting section 2203 may detect, as a characteristic region, an image region including a moving object. Note that the characteristic region detecting section 2203 may detect a plurality of characteristic regions having different characteristic types from each other, from each of the plurality of captured images. Note that the type of a characteristic may be defined using a type of an object (e.g., a person, a moving body) as an index. The type of the object may be determined based on the degree of matching of the form of the objects or the color of the objects. In this way, the characteristic region detecting section 2203 may detect, from a plurality of captured images, a plurality of characteristic regions respectively including different types of objects.

For example, the characteristic region detecting section 2203 may extract an object that matches a predetermined form pattern at a degree of matching higher than a predetermined degree of matching, from each of the plurality of captured images, and detect the regions in the captured images that include the extracted object, as characteristic regions sharing the same characteristic type. A plurality of form patterns may be determined for a plurality of characteristic types respectively. An exemplary form pattern is a form pattern of a face of a person. Note that a plurality of face patterns may be provided for a plurality of people respectively. Accordingly, the characteristic region detecting section 2203 may detect different regions including different people from each other, as different characteristic regions. Note that the characteristic region detecting section 2203 may also detect, as characteristic regions, regions including a part of a person such as head of a person, hand of a person, or at least a part of a living body other than a human being, not limited to a face of a person mentioned above. Note that a living body includes certain tissue existing inside the living body, such as tumor tissue or blood vessels in the living body. The characteristic region detecting section 2203 may also detect, as characteristic regions, regions including money, a card such as a cache card, a vehicle, or a number plate of a vehicle, other than a living body.

In addition to the pattern matching using a template matching, the characteristic region detecting section 2203 may also perform characteristic region detection based on the learning result such as by machine learning (e.g. AdaBoost) described in Japanese Patent Application Publication No. 2007-188419. For example, the characteristic region detecting section 2203 uses the image feature value extracted from the image of a predetermined subject and the image feature value extracted from the image of a subject other than the predetermined subject, to learn about the characteristic in the image feature value extracted from the image of the predetermined subject. Then, the characteristic region detecting section 2203 may detect, as a characteristic region, a region from which the image feature value corresponding to the characteristic matching the learned characteristic is extracted. Accordingly, the characteristic region detecting section 2203 can detect, as a characteristic region, a region including a predetermined subject.

In this way, the characteristic region detecting section 2203 detects a plurality of characteristic regions from a plurality of captured images included in each of a plurality of moving images. The characteristic region detecting section 2203 supplies information indicating a detected characteristic region to the compression control section 2210. Information indicating a characteristic region includes coordinate information of a characteristic region indicating a position of a characteristic region, type information indicating a type of a characteristic region, and information identifying a captured moving image from which a characteristic region is detected. In this way, the characteristic region detecting section 2203 detects a characteristic region in a moving image.

The compression control section 2210 controls compression of a moving image performed by the compression section 2230 for each characteristic region, based on the information indicating a characteristic region obtained from the characteristic region detecting section 2203. Note that the compression section 2230 may compress the captured image by causing to differ the degree of compression between the characteristic regions in the captured image and the region other than the characteristic regions in the captured image. For example, the compression section 2230 compresses the captured image by lowering the resolution of the region other than the characteristic regions in the captured image included in the moving image. In this way, the compression section 2230 compresses the image of the region other than the characteristic regions, by reducing the image quality of the image of the region other than the characteristic regions. In addition, the compression section 2230 compresses each of the image regions in a captured image depending on its degree of importance. Note that the concrete compression operation performed inside the compression section 2230 is detailed later.

Note that the model storage section 2270 stores a model expressing an object by a feature parameter. For example, the model storage section 2270 may store a model expressing an object by a statistical feature parameter. More specifically, the model storage section 2270 may store a model expressing an object by a principal component based on a principal component analysis. Note that the model storage section 2270 may store a model expressing the form of an object by a principal component based on a principal component analysis. In addition, the model storage section 2270 may store a model expressing the color of an object by a principal component based on a principal component analysis.

The parameter value calculating section 2260 adapts an image of the object included in the image of the characteristic region in the captured image to a model stored in the model storage section 2270, thereby calculating the value of the feature parameter in the model expressing the object included in the image of the characteristic region. Specifically, the parameter value calculating section 2260 calculates the weight of the principal component of the model. When the feature parameter is a principal component vector obtained by the principal component analysis, an example of the value of the feature parameter is a weighting factor for the principal component vector.

The parameter quantizing section 2280 selects a feature parameter whose value is to be outputted from the output section 2207. Specifically, the parameter quantizing section 2280 determines to which level of the principal components extracted by the principal component analysis the weighting factor should be outputted. For example, the parameter quantizing section 2280 determines that the weighting factor for the principal component should be outputted to the level predetermined according to the characteristic type of the characteristic region. The weighting factor to the level of the principal component determined by the parameter quantizing section 2280 is supplied to the correspondence processing section 2206.

The correspondence processing section 2206 associates information identifying the characteristic region detected from the captured image and the weighting factor, with the captured image. Specifically, the correspondence processing section 2206 associates the information identifying the characteristic region detected from the captured image and the weighting factor, with a compressed moving image including the captured image as a moving image constituting image. The output section 2207 outputs, to the image processing apparatus 2170, the compressed moving image to which the information identifying the characteristic region and the weighting factor are associated by the correspondence processing section 2206.

In this way, the output section 2207 outputs the value of the feature parameter calculated by the parameter value calculating section 2260 and image of the region other than characteristic regions. The output section 2207 may output the value of the feature parameter selected by the parameter quantizing section 2280 and the image of the region other than the characteristic regions whose image quality has been lowered by the compression section 2230.

Note that the compressed moving image outputted from the output section 2207 does not have to include pixel information for the characteristic region. In this way, the output section 2207 outputs the weight of the principal component calculated by the parameter value calculating section 2260 and the image of the region other than the characteristic region. The output section 2207 may output the value of the feature parameter calculated by the parameter value calculating section 2260 and the image of the region other than the characteristic region whose image quality has been lowered by the compression section 2230.

As explained above, the image processing apparatus 2120 can sufficiently reduce the amount of data by expressing the image of an object in the characteristic region by the model information as well as retaining information operable to reconstruct the image of the object in the future. Moreover, the amount of data can be substantially reduced by lowering the image quality of the background region having a low degree of importance compared to the characteristic regions.

Note that the model storage section 2270 may store models of different types of objects in association with the types. The parameter value calculating section 2260 may calculate the value of the feature parameter by adapting the image of the object included in the image of the characteristic region in the captured image, to the model stored by the model storage section 2270 in association with the type of the object included in the characteristic region. In this case, the output section 2207 desirably outputs the value of the feature parameter calculated by the parameter value calculating section 2260, the type of the object included in the characteristic region, and the image of the region other than the characteristic region whose image quality has been lowered by the compression section 2230. This allows the image processing apparatus 2170 to select and reconstruct the model of the adequate type.

The model storage section 2270 may also store models of an object in different directions, in association with the directions. The parameter value calculating section 2260 may calculate the value of the feature parameter by adapting the image of the object included in the image of the characteristic region in the captured image, to the model stored by the model storage section 2270 in association with the captured direction of the object included in the characteristic region. In this case, the output section 2207 desirably outputs the value of the feature parameter calculated by the parameter value calculating section 2260, the captured direction of the object included in the characteristic region, and the image of the region other than the characteristic region whose image quality has been lowered by the compression section 2230.

The model storage section 2270 may also store models of an object illuminated in different illumination conditions, in association with the illumination conditions. The parameter value calculating section 2260 may calculate the value of the feature parameter by adapting the image of the object included in the image of the characteristic region in the captured image, to the model stored by the model storage section 2270 in association with the illumination condition used to illuminate the object included in the characteristic region. In this case, the output section 2207 desirably outputs the value of the feature parameter calculated by the parameter value calculating section 2260, the illumination condition used to illuminate the object included in the characteristic region, and the image of the region other than the characteristic region whose image quality has been lowered by the compression section 2230.

In this way, the model storage section 2270 stores a plurality of models in association with the type of the object, the direction of the object, and the illumination condition. Therefore, the image of the object of the characteristic region can be expressed using a more adequate model, thereby reducing the amount of data while maintaining the image quality of the characteristic region.

Note that with reference to FIG. 2, the function and operation of the parameter value calculating section 2260 and the parameter value quantizing section 2280 of the image processing apparatus 120 are briefly explained. However, the parameter value calculating section 2260 and the parameter quantizing section 2280 of the image processing apparatus 120 explained with reference to FIG. 1 through FIG. 9 may have substantially the same function and operation as the function and operation of the parameter value calculating section 2260 and the parameter quantizing section 2280 explained with reference to the present drawing and the drawings thereafter.

In addition, the model storage section 270, the characteristic region detecting section 203, the compression control section 210, the compression section 230, the correspondence processing section 206, and the output section 207 explained with reference to FIG. 2 through FIG. 9 may have substantially the same function and operation as the function and operation of the model storage section 2270, the characteristic region detecting section 2203, the compression control section 2210, the compression section 2230, the correspondence processing section 2206, and the output section 2207 explained with reference to the present drawing and the drawings thereafter.

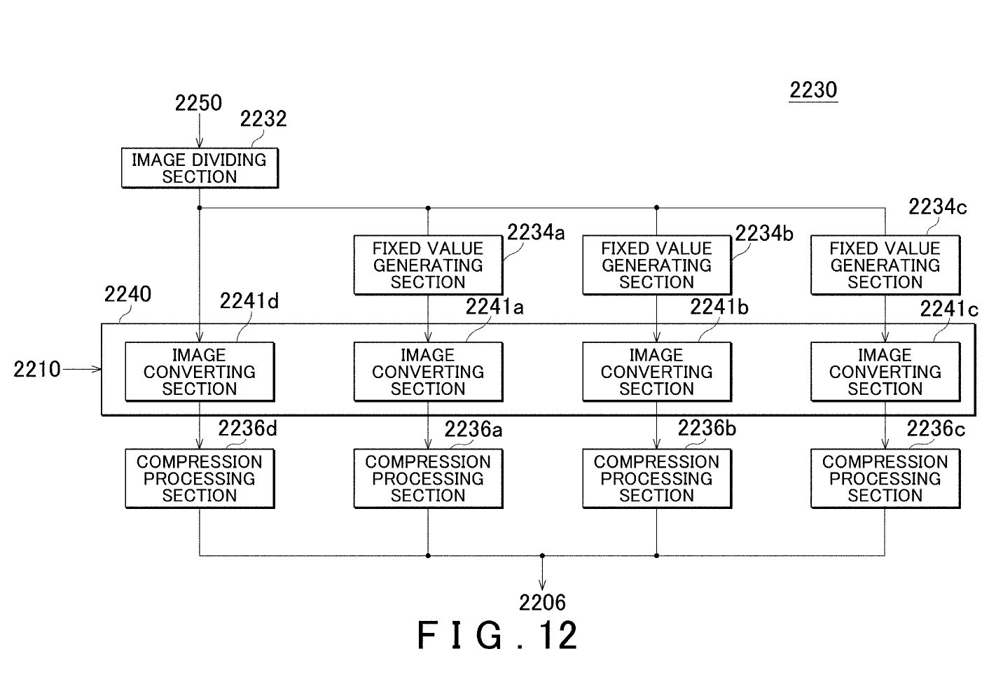

FIG. 12 shows another example of a block configuration of a compression section 2230. The compression section 2230 includes an image dividing section 2232, a plurality of fixed value generating sections 2234a-c (hereinafter occasionally collectively referred to as “fixed value generating section 2234”), an image quality converting unit 2240 that includes a plurality of image quality converting sections 2241 a-d (hereinafter collectively referred to as “image quality converting section 2241”), and a plurality of compression processing sections 2236a-d (hereinafter occasionally collectively referred to as “compression processing section 2236”).

The image dividing section 2232 obtains a plurality of captured image from the image obtaining section 2250. Then, the image dividing section 2232 divides characteristic regions from a background region other than the characteristic region, in the plurality of captured images. Specifically, the image dividing section 2232 divides each of a plurality of characteristic regions from a background region other than the characteristic regions, in the plurality of captured images. In this way, the image dividing section 2232 divides characteristic regions from a background region in each of the plurality of captured images.

The compression processing section 2236 compresses a characteristic region image that is an image of a characteristic region and a background region image that is an image of a background region at different degrees from each other. Specifically, the compression processing section 2236 compresses a characteristic region moving image including a plurality of characteristic region images, and a background region moving image including a plurality of background region images at different degrees from each other.

Specifically, the image dividing section 2232 divides a plurality of captured images to generate a characteristic region moving image for each of a plurality of characteristic types. The fixed value generating section 2234 generates, for each characteristic region image included in a plurality of characteristic region moving images respectively generated according to characteristic types, a fixed value of a pixel value of a region other than a characteristic region of each characteristic type. Specifically, the fixed value generating section 2234 sets the pixel value of the region other than the characteristic region to be a predetermined pixel value.

The image quality converting section 2241 converts the image quality of an image of a characteristic region and of an image of a background region. For example, the image quality converting section 2241 converts at least one of the resolution, the number of gradations, the dynamic range, or the number of included colors, for each of images of characteristic regions and an image of a background region resulting from the division. Then, the compression processing section 2236 compresses the plurality of characteristic region moving images for each characteristic type. For example, the compression processing section 2236 MPEG compresses the plurality of characteristic region moving images for each characteristic type.

Note that the fixed value generating sections 2234a, 2234b, and 2234c respectively perform the fixed value processing on the characteristic region moving image of the first characteristic type, the characteristic region moving image of the second characteristic type, and the characteristic region moving image of the third characteristic type. The image quality converting sections 2241a, 2241b, 2241c, and 2241d respectively convert the image qualities of the characteristic region moving image of the first characteristic type, the characteristic region moving image of the second characteristic type, the characteristic region moving image of the third characteristic type, and the background region moving image. Then, the compression processing sections 2236a, 2236b, 2236c, and 2236d compress the characteristic region moving image of the first characteristic type, the characteristic region moving image of the second characteristic type, the characteristic region moving image of the third characteristic type, and the background region moving image.

Note that the compression processing sections 2236a-c compress a characteristic region moving image at a predetermined degree according to a characteristic type. For example, the compression processing section 2236 may convert characteristic region moving images into respectively different resolutions predetermined according to characteristic types, and compress the converted characteristic region moving images. When compressing the characteristic region moving image using MPEG encoding, the compression processing section 2236 may also compress the characteristic region moving images with respectively different quantization parameters predetermined according to characteristic types.

Note that the compression processing section 2236d compresses a background region moving image. Note that the compression processing sections 2236d may compress a background region moving image at a degree higher than any degree adopted by the compression processing sections 2236a-c. The characteristic region moving image and the background region moving image compressed by the compression processing section 2236 are supplied to the correspondence processing section 2206.

Since the region other than the characteristic region has been subjected to the fixed value processing by the fixed value generating section 2234, when the compression processing section 2236 performs prediction coding such as MPEG encoding, the amount of difference between the image and the predicted image in the region other than the characteristic region can be substantially reduced. Therefore, the compression ratio of the characteristic region moving image can be substantially enhanced.

In this way, by reducing the image quality of the captured image, the compression section 2230 generates an image to be an input image to the image processing apparatus 2170. Specifically, the compression section 2230 generates an image to be an input image to the image processing apparatus 2170, such as by reducing the resolution, the number of gradations, and the number of used colors of the captured image. In addition, the compression section 2230 may for example generate an image to be an input image to the image processing apparatus 2170, by lowering the spatial frequency component in the captured image.

Note that in this drawing, each of the plurality of compression processing sections 2236 included in the compression section 2230 compresses the images of the plurality of characteristic regions and the image of the background region. However, in another embodiment, the compression section 2230 may include a single compression processing section 2236, and this single compression processing section 2236 may compress the images of the plurality of characteristic regions and the image of the background region at respectively different degrees. For example, an arrangement is possible in which the images of the plurality of characteristic regions and the image of the background region are sequentially supplied in time division to the single compression processing section 2236, and the single compression processing section 2236 sequentially compresses the images of the plurality of characteristic regions and the image of the background region at respectively different degrees.

Alternatively, a single compression processing section 2236 may compress the images of the plurality of characteristic regions and the image of the background region at different degrees from each other, by respectively quantizing the image information of the plurality of characteristic regions and the image information of the background region at different quantization factors from each other. An arrangement is also possible in which the images resulting from converting the images of the plurality of characteristic regions and the image of the background region are converted into respectively different image qualities are supplied to the single compression processing section 2236, and the single compression processing section 2236 compresses the images of the plurality of characteristic regions and the image of the background region respectively. Note that this image quality conversion may be performed by a single image quality converting unit 2240. Also in such an embodiment described above in which a single compression processing section 2236 performs quantization using different quantization factors for each of regions and the images converted into different image qualities for each of regions are converted by a single compression processing section 2236, the single compression processing section 2236 may compress a single image, or may compress the images divided by the image dividing section 2232 respectively as in the present drawing. Note that when a single compression processing section 2236 compresses a single image, the dividing processing by the image dividing section 2232 and the fixed value processing by the fixed value generating section 2234 are unnecessary, and so the compression section 2230 does not have to include any image dividing section 2232 or fixed value generating section 2234.

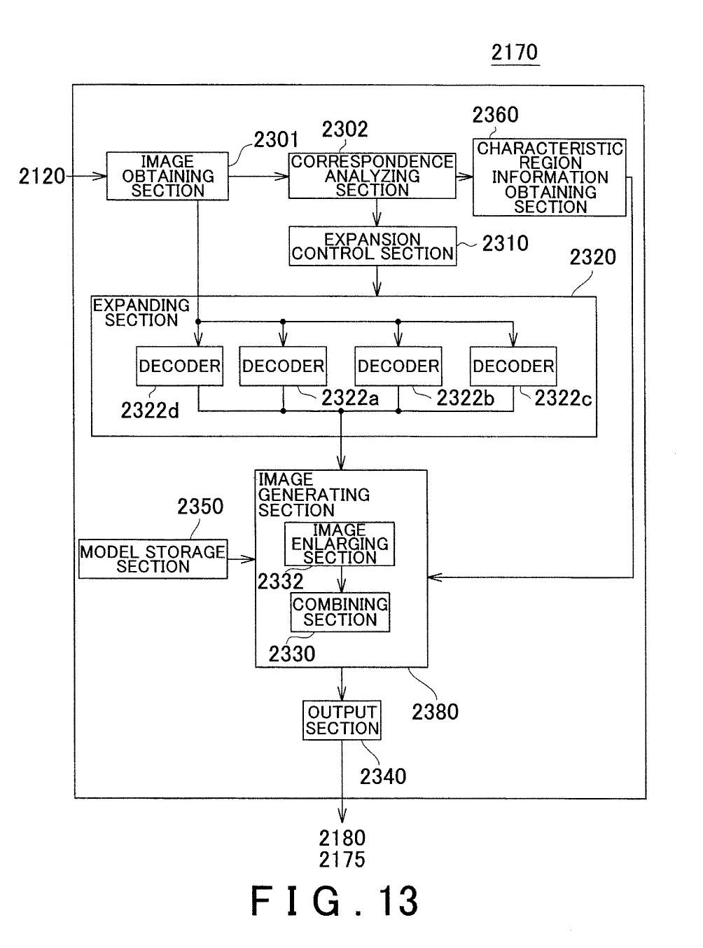

FIG. 13 shows an example of a block configuration of an image processing apparatus 2170. The image processing apparatus 2170 includes an image obtaining section 2301, a correspondence analyzing section 2302, an expansion control section 2310, an expanding section 2320, an image generating section 2380, a characteristic region information obtaining section 2360, a model storage section 2350, and an output section 2340. The image generating section 2380 includes an enlarging section 2332 and a combining section 2330.

The image obtaining section 2301 obtains a compressed moving image compressed by the compression section 2230. Specifically, the image obtaining section 2301 obtains a compressed moving image including a plurality of characteristic region moving images and a background region moving image. More specifically, the image obtaining section 2301 obtains a compressed moving image to which attached are characteristic region information and a feature parameter. In this way, the image obtaining section 2301 obtains, from the output section 2207, the value of the feature parameter and the captured image whose image quality has been lowered. Specifically, the image obtaining section 2301 obtains the captured image whose image quality has been lowered in the region other than the characteristic region, and the value of the feature parameter.

The correspondence analyzing section 2302 then separates the moving image data obtained by the image obtaining section 2301, into a plurality of characteristic region moving images and a background region moving image, characteristic region information, and a characteristic region parameter value, and supplies the plurality of characteristic region moving images and the background region moving image to the expanding section 2320. In addition, the correspondence analyzing section 2302 supplies the position of the characteristic region and the characteristic type to the expansion control section 2310 and the characteristic region information obtaining section 2360. In addition, the correspondence analyzing section 2302 supplies the value of the feature parameter to the characteristic region information obtaining section 2360. In this way, the characteristic region information obtaining section 2360 can obtain the information indicating a characteristic region in each of a plurality of captured images (i.e., information indicating a position of a characteristic region) and the value of the feature parameter. The characteristic region information obtaining section 2360 supplies, to the image generating section 2380, the information indicating the position of the characteristic region and the value of the feature parameter.

The expansion control section 2310 controls the expanding processing by the expanding section 2320, according to the position of the characteristic region and the characteristic type obtained from the correspondence analyzing section 2302. For example, the expansion control section 2310 controls the expanding section 2320 to expand each region of a moving image represented by the compressed moving image, according to a compression method adopted by the compression section 2230 in compressing each region of the moving image according to the position of the characteristic region and the characteristic type.

The following explains the operation of each constituting element of the expanding section 2320. The expanding section 2320 includes a plurality of decoders 2322a-d (hereinafter collectively referred to as “decoder 2322”). The decoder 2322 decodes one of the plurality of characteristic region moving images and the background region moving image, which have been encoded. Specifically, the decoders 2322a, 2322b, 2322c, and 2322d respectively decode the first, second, third characteristic region moving images and a background region moving image The expanding section 2320 supplies the first, second, third characteristic region moving images and the background region moving image, which have been decoded, to the image generating section 2380.

The image generating section 2380 generates a single moving image for display based on the first, second, third characteristic region moving images, the background region moving image, and the characteristic region information. The output section 2340 then outputs the characteristic region information obtained from the correspondence analyzing section 2302 and the moving image for display to the display apparatus 2180 or to the image DB 2175. Note that the image DB 2175 may record, in a nonvolatile recording medium such as a hard disk, the position, the characteristic type, and the number of characteristic region(s) indicated by the characteristic region information, in association with information identifying the captured image included in the moving image for display. Note that the output section 2340 can function as an image output section in the present invention.

The model storage section 2350 stores the model that is the same as the model stored in the model storage section 2270. The image generating section 2380 may generate a high image quality image of the object included in the characteristic region, by adapting the image of the object included in the characteristic region to the model stored in the model storage section 2350. Specifically, the image generating section 2380 may generate a high image quality image of the object by weighting the principal component vector stored in the model storage section 2350, with a weighting factor which is an example of the value of the feature parameter. In this way, the image generating section 2380 generates the image of the object included in the image of the characteristic region, based on the value of the feature parameter.

Note that the parameter value calculating section 2260 may calculate the value of the feature parameter in the model, representing the form of the object captured in the image of the characteristic region, by adapting the image of the object included in the image of the characteristic region in the captured image, to the model stored in the model storage section 2270. Then, the compression section 2230 may compress the captured image by lowering the image quality of the characteristic region and the region other than the characteristic region in the captured image. The output section 2207 may output the value of the feature parameter calculated by the parameter value calculating section 2260 and the captured image whose image quality has been lowered by the compression section 2230.

In this case, the image generating section 2380 generates the image of the object included in the image of the characteristic region, by generating the form of the object included in the image of the characteristic region from the model based on the value of the feature parameter, and using the generated form of the object and the pixel value of the image of the characteristic region in the captured image obtained by the image obtaining section 2250. Specifically, the image generating section 2380 generates the image of the object included in the image of the characteristic region, by generating the form of the object included in the image of the characteristic region from the model based on the value of the feature parameter, and using the generated form of the object and the pixel value of the image of the characteristic region expanded by the expanding section 2320.

Note that the characteristic region information obtaining section 2360 may obtain the type of the object, the direction of the object, and the illumination condition outputted by the output section 2207 in association with the compressed moving image. The image generating section 2380 may generate a high image quality image of an object, by weighting the principal component vector stored in the model storage section 2350 in association with the type of the object, the direction of the object, and the illumination condition, using the weighting factor obtained by the characteristic region information obtaining section 2360.

The image enlarging section 2332 enlarges the image of the region other than the characteristic region. The combining section 2330 combines the high image quality image of the object in the characteristic region and the image of the enlarged region other than the characteristic region.

Then, the output section 2340 outputs an image including the high image quality image and the image other than the characteristic region. Specifically, the output section 2340 outputs a moving image for display including the captured image obtained by the combining section 2330 as described above as a moving image constituting image. Note that the model storage section 350 and the image generating section 380 explained above with reference to FIG. 2 through FIG. 9 may have substantially the same function and operation as the function and operation of the model storage section 2350 and the image generating section 2380 explained with reference to the present drawing and the drawings thereafter.

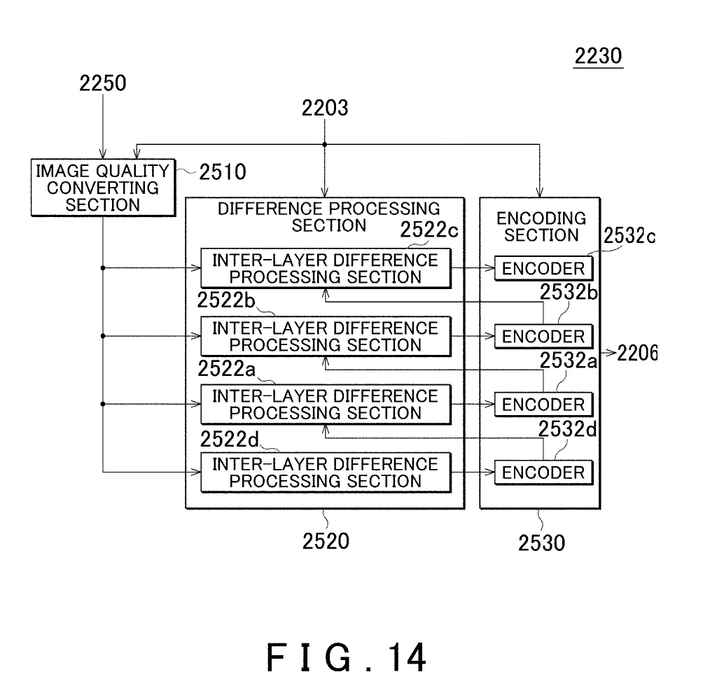

FIG. 14 shows an example of another block configuration of the compression section 2230. The compression section 2230 in the present configuration compresses a plurality of captured images by means of coding processing that is spatio scalable according to the characteristic type.

The compression section 2230 in the present configuration includes an image quality converting section 2510, a difference processing section 2520, and an encoding section 2530. The difference processing section 2520 includes a plurality of inter-layer difference processing sections 2522a-d (hereinafter collectively referred to as “inter-layer difference processing section 2522”). The encoding section 2530 includes a plurality of encoders 2532a-d (hereinafter collectively referred to as “encoder 2532”).

The image quality converting section 2510 obtains a plurality of captured images from the image generating section 2250. In addition, the image quality converting section 2510 obtains information identifying the characteristic region detected by the characteristic region detecting section 2203 and information identifying the characteristic type of the characteristic region. The image quality converting section 2510 then generates the captured images in number corresponding to the number of characteristic types of the characteristic regions, by copying the captured images. The image quality converting section 2510 converts the generated captured images into images of resolution according to the respective characteristic types.

For example, the image quality converting section 2510 generates a captured image converted into resolution according to a background region (hereinafter referred to as “low resolution image”), a captured image converted into first resolution according to a first characteristic type (hereinafter referred to as “first resolution image”), a captured image converted into second resolution according to a second characteristic type (hereinafter referred to as “second resolution image”), and a captured image converted into third resolution according to a third characteristic type (hereinafter referred to as “third resolution image”). Here, the first resolution image has a higher resolution than the resolution of the low resolution image, and the second resolution image has a higher resolution than the resolution of the first resolution image, and the third resolution image has a higher resolution than the resolution of the second resolution image.

The image quality converting section 2510 supplies the low resolution image, the first resolution image, the second resolution image, and the third resolution image, respectively to the inter-layer difference processing section 2522d, the inter-layer difference processing section 2522a, the inter-layer difference processing section 2522b, and the inter-layer difference processing section 2522c. Note that the image quality converting section 2510 supplies a moving image to each of the inter-layer difference processing sections 2522 as a result of performing the image quality converting processing to each of the plurality of captured images.

Note that the image quality converting section 2510 may convert the frame rate of the moving image supplied to each of the inter-layer difference processing sections 2522 according to the characteristic type of the characteristic region. For example, the image quality converting section 2510 may supply, to the inter-layer difference processing section 2522d, the moving image having a frame rate lower than the frame rate of the moving image supplied to the inter-layer difference processing section 2522a. In addition, the image quality converting section 2510 may supply, to the inter-layer difference processing section 2522a, the moving image having a frame rate lower than the frame rate of the moving image supplied to the inter-layer difference processing section 2522b, and may supply, to the inter-layer difference processing section 2522b, the moving image having a frame rate lower than the frame rate of the moving image supplied to the inter-layer difference processing section 2522c. Note that the image quality converting section 2510 may convert the frame rate of the moving image supplied to the inter-layer difference processing section 2522, by thinning the captured images according to the characteristic type of the characteristic region. Note that the image quality converting section 2510 may perform the similar image conversion to the image quality converting section 2241 explained with reference to FIG. 12.

The inter-layer difference processing section 2522d and the encoder 2532d perform prediction coding on the background region moving image including a plurality of low resolution images. Specifically, the inter-layer difference processing section 2522 generates a differential image representing a difference from the predicted image generated from the other low resolution images. Then, the encoder 2532d quantizes the conversion factor obtained by converting the differential image into spatial frequency component, and encodes the quantized conversion factor using entropy coding or the like. Note that such prediction coding processing may be performed for each partial region of a low resolution image.

In addition, the inter-layer difference processing section 2522a performs prediction coding on the first characteristic region moving image including a plurality of first resolution images supplied from the image quality converting section 2510. Likewise, the inter-layer difference processing section 2522b and the inter-layer difference processing section 2522c respectively perform prediction coding on the second characteristic region moving image including a plurality of second resolution images and on the third characteristic region moving image including a plurality of third resolution images. The following explains the concrete operation performed by the inter-layer difference processing section 2522a and the encoder 2532a.

The inter-layer difference processing section 2522a decodes the first resolution image having been encoded by the encoder 2532d, and enlarges the decoded image to an image having a same resolution as the first resolution. Then, the inter-layer difference processing section 2522a generates a differential image representing a difference between the enlarged image and the low resolution image. During this operation, the inter-layer difference processing section 2522a sets the differential value in the background region to be 0. Then, the encoder 2532a encodes the differential image just as the encoder 2532d has done. Note that the encoding processing may be performed by the inter-layer difference processing section 2522a and the encoder 2532a for each partial region of the first resolution image.

When encoding the first resolution image, the inter-layer difference processing section 2522a compares the amount of encoding predicted to result by encoding the differential image representing the difference from the low resolution image and the amount of encoding predicted to result by encoding the differential image representing the difference from the predicted image generated from the other first resolution image. When the latter amount of encoding is smaller than the former, the inter-layer difference processing section 2522a generates the differential image representing the difference from the predicted image generated from the other first resolution image. When the encoding amount of the first resolution image is predicted to be smaller as it is without taking any difference with the low resolution image or with the predicted image, the inter-layer difference processing section 2522a does not have to calculate the difference from the low resolution image or the predicted image.

Note that the inter-layer difference processing section 2522a does not have to set the differential value in the background region to be 0. In this case, the encoder 2532a may set the data after encoding with respect to the information on difference in the non-characteristic region to be 0. For example, the encoder 2532a may set the conversion factor after converting to the frequency component to be 0. When the inter-layer difference processing section 2522d has performed prediction coding, the motion vector information is supplied to the inter-layer difference processing section 2522a. The inter-layer difference processing section 2522a may calculate the motion vector for a predicted image, using the motion vector information supplied from the inter-layer difference processing section 2522d.

Note that the operation performed by the inter-layer difference processing section 2522b and the encoder 2532b is substantially the same as the operation performed by the inter-layer difference processing section 2522a and the encoder 2532a, except that the second resolution image is encoded, and when the second resolution image is encoded, the difference from the first resolution image after encoding by the encoder 2532a may be occasionally calculated, and so is not explained below. Likewise, the operation performed by the inter-layer difference processing section 2522c and the encoder 2532c is substantially the same as the operation performed by the inter-layer difference processing section 2522a and the encoder 2532a, except that the third resolution image is encoded, and when the third resolution image is encoded, the difference from the second resolution image after encoding by the encoder 2532b may be occasionally calculated, and so is not explained below.

As explained above, the image quality converting section 2510 generates, from each of the plurality of captured images, a low image quality image and a characteristic region image having a higher image quality than the low image quality image at least in the characteristic region. The difference processing section 2520 generates a characteristic region differential image being a differential image representing a difference between the image of the characteristic region in the characteristic region image and the image of the characteristic region in the low image quality image. Then, the encoding section 2530 encodes the characteristic region differential image and the low image quality image respectively.

The image quality converting section 2510 also generates low image quality images resulting from lowering the resolution of the plurality of captured images, and the difference processing section 2520 generates a characteristic region differential image representing a difference between the image of the characteristic region in the characteristic region image and the image resulting from enlarging the image of the characteristic region in the low image quality image. In addition, the difference processing section 2520 generates a characteristic region differential image having a characteristic region and a non-characteristic region, where the characteristic region has a spatial frequency component corresponding to a difference between the characteristic region image and the enlarged image converted into a spatial frequency region, and an amount of data for the spatial frequency component is reduced in the non-characteristic region.

As explained above, the compression section 2230 can perform hierarchical encoding by encoding the difference between the plurality of inter-layer images having different resolutions from each other. As can be understood, a part of the compression method adopted by the compression section 2230 in the present configuration includes the compression method according to H.264/SVC. Note that to expand such a hierarchically compressed moving image, the image processing apparatus 2170 can generate a captured image having an original resolution by decoding the moving image data of each layer and adding the decoded captured image in the layer for which the difference was taken in the region for which encoding was performed using the inter-layer difference.

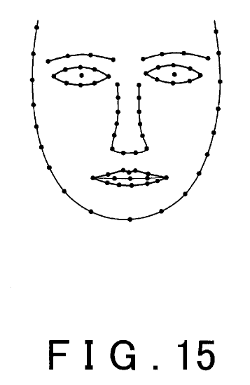

FIG. 15 shows an example of a characteristic point in a human face. As explained above with reference to FIG. 11 and FIG. 12, the model storage section 2270 and the model storage section 2350 store a model expressing an object using a feature parameter. The following explains a method of utilizing an AAM method in generating the model of a face of a person that is an example of the object, as an example of a generating method of generating a model stored by the model storage section 2270 and the model storage section 2350.

“n” characteristic points representing the facial form are set with respect to each of the plurality of facial images (hereinafter referred to as “sample image”) representing a facial portion of a person as a sample. Note that the number of characteristic points is assumed to be smaller than the pixel number of the facial image. Each characteristic point may be determined in advance to show a portion of the face such that the first characteristic point represents the left end of the left eye, the eleventh characteristic point represents the center between the eye brows, and so on. In addition, each characteristic point may be set manually, or automatically by recognition processing.

Then, based on the characteristic points set in each sample image, the average form of the face is calculated. Specifically, the average of the positional coordinates for each characteristic point showing the same portion is obtained in each sample image. Then, the principal component analysis is performed based on the positional coordinates of the characteristic points representing the facial form in each sample image and its average form. As a result, a facial form S can be expressed as S=S₀+Σpᵢbᵢ(i=1−n).

Here, “S” represents a form vector represented by arranging the positional coordinates of each characteristic point of the facial form (x1, y1, . . . , xₙ, yₙ), “S₀” represents an average facial form vector represented by arranging the positional coordinates of each characteristic point in the average facial form, “pᵢ” represents an eigenvector showing the i-th principal component of the facial form obtained by the principal component analysis, and “bᵢ” represents the weighting factor for each eigenvector pᵢ.

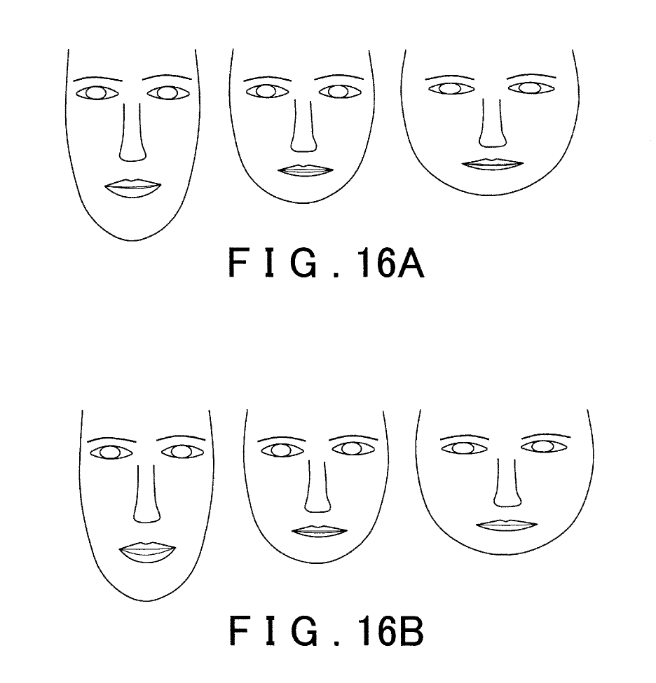

FIG. 16A and FIG. 16B schematically show an example of change in facial form when a weighting factor b is changed. The present drawings schematically show the change in facial form in changing the values of the weighting factors b₁ and b₂ with respect to the eigenvectors p₁, p₂ of the upper two principal components obtained by the principal component analysis. FIG. 16A shows change in facial form when the weighting factor b₁ is changed, and FIG. 16B shows change in facial form when the weighting factor b₂ is changed. In each case of FIG. 16A and FIG. 16B, the center of three facial forms for each principal component shows an average facial form.

In this case, the component contributing to the outline form of the face is extracted as the first principal component, as a result of the principal component analysis. By changing the weighting factor b₁, the facial form changes from a) the thin face shown in the left end to a) the round face shown in the right end. As the second principal component, the components contributing to the open/close state of the mouth and the length of the chin are extracted, and so by changing the weighting factor b₂, the facial form changes from b) the long chin with the mouth open in the left end to b) the short chin with the mouth closed in the right end. Note that each person may interpret differently as to which element of form a principal component contributes. The principal component analysis enables to extract a principal component expressing a larger difference in form in each used sample image, as a lower-order principal component.

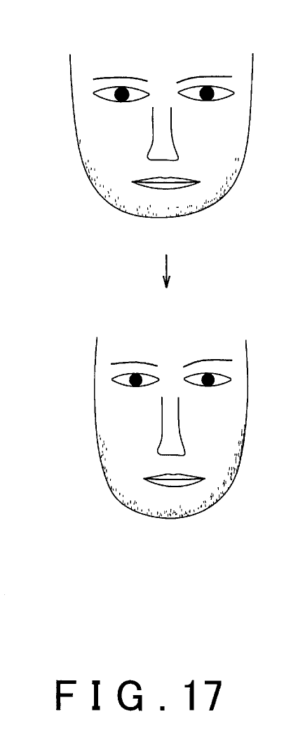

FIG. 17 shows an example of an image obtained by converting a sample image into an average facial form. Each sample image is converted (warped) into an average facial form. Concretely, the amount of shift between each sample image and an average facial form is calculated for each characteristic point. Then using thus calculated amount of shift, the amount of shift of each sample image to an average facial form for each pixel is calculated, to warp each sample image to an average facial form for each pixel.

Then, the principal component analysis is conducted using, as a variable, the pixel value of the color component of R, B of each pixel of each sample image after conversion into an average facial form. As a result, the pixel value of the color component of R, G, B in the average facial form of an arbitrary facial image can be approximated using an expression A=A₀+Σqᵢλᵢ(i=1−m).

Here, “A” represents the vector (r1, g1, b1, r2, g2, b2, . . . , rm, gm, bm) represented by arranging each pixel value of R, G, B color components of each pixel in an average form. Note that “r,” “g,” and “b” represent the pixel value of R, G, B color components respectively, 1−m represent a suffix identifying each pixel, and “m” represents the total number of pixels in the average facial form. Note that the order of arrangement of the vector components is not limited as stated above.

In addition, A₀ represents an average vector represented by arranging the average of each pixel value of R, G, B color components of each pixel of each sample image in the average facial form, qᵢ represents an eigenvector representing i-th principal component for the pixel value of R, G, B color components of the face obtained by the principal component analysis, and λᵢ represents a weighting factor for each eigenvector qᵢ.

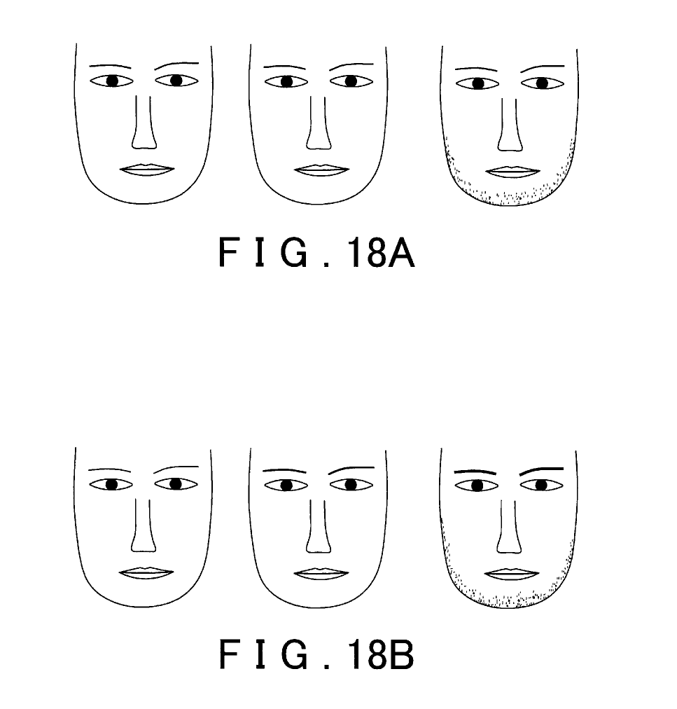

FIG. 18A and FIG. 18B schematically show an example of change in pixel value when a weighting factor q is changed. The present drawings schematically show the change in pixel value of the face in changing the values of the weighting factors λ₁ and λ₂ with respect to the eigenvectors q₁, q₂ of the upper two principal components obtained by the principal component analysis. FIG. 18A shows change in pixel value when the weighting factor λ₁ is changed, and FIG. 18B shows change in pixel value when the weighting factor λ₂ is changed. In each case of FIG. 18A and FIG. 18B, the center of three facial forms for each principal component shows an average pixel value.

In the present example, the component contributing whether there is beards is extracted as the first principal component, as a result of the principal component analysis. By changing the weighting factor λ₁, the face changes from a) the beardless face shown in the left end to a) the face with thick beards shown in the right end. As the second principal component, the component contributing to the thickness of the eyebrow is extracted, and so by changing the weighting factor λ₂, the face changes from b) the face with scarce eyebrow at the left end to b) the face with thick eyebrow at the right end.

The processing explained with reference to FIG. 15 through FIGS. 18A-18B enables to generate the facial model. The model represents a face by a plurality of eigenvectors pi representing the facial form and an eigenvector qᵢ representing the pixel value of the face in the average facial form. The summation value of each eigenvector of the model is substantially smaller than the number of pixels forming the facial image. Note that in the above-stated example, different weighting factors bᵢ, λᵢ are used for the facial form and the pixel values of R, G, B color components to express different facial images, since there is correlation between variations of the facial form and the color component pixel values, it is also possible to perform principal component analysis on the feature parameter including both of the characteristic point and the pixel value.

The following shows an example of processing of compressing the image of the object included in the characteristic region using the model stored in the model storage section 2270. The parameter value calculating section 2260 normalizes the input facial image included in the characteristic region, to calculate the pixel value of the R, G, B color component in the average facial form. Note that the input facial image is not always taken from the front, or may be taken under an illumination condition different from the illumination condition under which the sample image was taken. Therefore, not limited to processing to align the characteristic points of the front face as stated above, the normalization in this specification also includes converting into the facial image captured under the same image capturing environment as that of the sample image, such as conversion processing for converting the direction of the input facial image as taken from the slanting direction into the facial image as taken from the front, and shadow removal processing to remove the effect of the shadow due to illumination.

The parameter value calculating section 2260 calculates the weighting factor λᵢ by projecting the pixel value difference from the average face onto the principal component vector qᵢ. Specifically, the parameter value calculating section 2260 can calculate the weighting factor λᵢ by the inner product with the principal component vector qᵢ. In addition, the parameter value calculating section 2260 calculates the characteristic point S of the face using the similar processing as the above-described calculation of the pixel value A. Specifically, the parameter value calculating section 2260 calculates the weighting factor bᵢ by projecting the difference in position of the characteristic points from the average face on the principle vector pᵢ.

As explained above, the parameter value calculating section 2260 can calculate the weighting factors bᵢ and λᵢ as the value of the feature parameter. The following explains generation of the high image quality image performed by the image generating section 2380.

The image generating section 2380 uses the obtained weighting factor λᵢ, the pixel value A₀ of the average face, and the principal component vector qᵢ, to calculate the pixel value “A” in the average facial form. In addition, the image generating section 2380 calculates the characteristic point “A” using the obtained weighting factor bᵢ, the characteristic point S₀ of the average face, and the principal component vector pᵢ. Then, the image generating section 2380 performs inverse conversion of the above-described normalization processing excluding the processing to align the characteristic points, onto the image represented by the pixel value “A” and the characteristic point “A.” Note that the content of the normalization processing explained above may be transmitted from the image processing apparatus 2120 to the image processing apparatus 2170, to be used by the image generating section 2380 when performing the inverse conversion explained above.

According to the above-described processing, the image generating section 2380 generates a high image quality image having a higher image quality than the image quality of the captured image, based on the image of the characteristic region in the captured image outputted from the output section 2207. Specifically, the image generating section 2380 may generate an image of a higher resolution, a sharper image, an image having less noise, an image having more number of gradations, or an image having a larger number of colors, than the captured image outputted from the output section 2207.

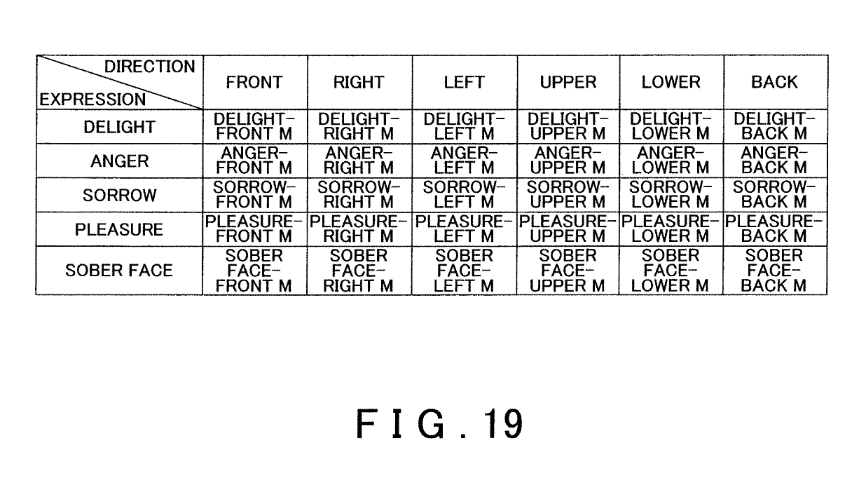

FIG. 19 shows, in a table format, an example of a model stored in a model storage section 2270 and a model storage section 2350. The model storage section 2270 and the model storage section 2350 store a model for each combination of expression and direction. Exemplary expressions include faces in each state of delight, anger, sorrow, and pleasure, and a sober face, and exemplary directions include front, upper, lower, right, left, and back.

The parameter value calculating section 2260 can identify the expression of the face and the direction of the face, based on the facial image included in the characteristic region, and calculate the above-described weighting factor using the model stored in the model storage section 2270 in association with the identified combination of expression and direction.

Note that the output section 2207 may transmit information identifying the used model, to the information processing apparatus 2170. Then, the image generating section 2380 can perform the above-described reconstruction processing using the model identified by the information.

Note that the image generating section 2380 may identify the expression from the form of the mouth and/or the eyes, and may identify the facial direction based on such as the positional relation of the eyes, the mouth, the nose, and the ears. Note that the image processing apparatus 2120 may be used to identify the facial expression and the facial direction, and the output section 2207 may be used to output the facial expression and the facial direction in association with the captured image.

Moreover, the model storage section 2270 and the model storage section 2350 may store the model in association with the illumination condition, as well as in association with the facial expression and the facial direction. For example, the model storage section 2270 and the model storage section 2350 may store the model in association with the strength and the direction of the illumination. The parameter value calculating section 2260 identifies the illumination condition for the face based on the facial image included in the characteristic region. For example, the parameter value calculating section 2260 may identify the strength and direction of the illumination based on the position and size of the shadow, and calculate the weighting factor using the model stored in the model storage section 2270 in association with the identified strength and direction of the illumination.

The above-described example has stated generation of a model for expressing the entire face, feature parameter extraction and reconstruction using the model. However not limited to the model for the entire face, the image processing system 2010 may also use a model for each portion of a face. The image processing system 2010 may also use a model of a face different for each sex and/or race (or each portion of these faces). Furthermore, not limited to a human model as stated above, the image processing system 2010 may store the model for each type of object under monitoring (e.g., vehicle and ship) by the image processing system 2010. The image generating section 2380 may perform reconstruction by selecting a model according to the type of object. The types of object may be detected in the image processing apparatus 2120 to be transmitted to the image processing apparatus 2170 in association with the captured image.

As explained above, the model storage section 2270 and the model storage section 2350 may store models of different types of object in association with the types. The characteristic region information obtaining section 2360 obtains information indicating the type of object included in the characteristic region in the inputted image. The image generating section 2380 converts, into a high image quality image, the image of the object included in the characteristic region in the captured image, by adapting it to the model stored in the model storage section 2350 in association with the type of the object included in the characteristic region obtained by the characteristic region information obtaining section 2360.

As explained above, the model storage section 2270 and the model storage section 2350 store the model which is an example of the learning data, for each portion (e.g., eyes, nose, and mouth) of a face which is an example of the information identifying a type of object. Here, the learning data may include, other than the models described above, a low frequency component and a high frequency component of the image of the object respectively extracted from a multiple sample images of the object. Here, for each type of the plurality of objects, the low frequency component of the image of the object can be clustered into a plurality of clusters, by means of K-means or the like. In addition, a representative low frequency component (e.g., barycenter value) can be determined for each cluster. Note that the model storage section 2270 may store information identifying the high frequency component in association with the low frequency component of the image of the object. The model storage section 2350 may store the high frequency component in association with the information identifying the high frequency component.

The parameter value calculating section 2260 extracts the low frequency component from the image of the object included in the captured image. Then, the parameter value calculating section 2260 identifies the cluster whose representative low frequency component is determined to be the value matching the extracted low frequency component, from among the cluster of frequency components extracted from the sample images of the type of the object. The parameter value calculating section 2260 identifies information identifying the cluster of the high frequency component stored in the model storage section 2270 in association with the low frequency component included in the identified cluster. In this way, the parameter value calculating section 2260 can identify the cluster of the high frequency component correlated to the low frequency component extracted from the object included in the captured image. The information identifying the cluster of the high frequency component identified by the parameter value calculating section 2260 is outputted from the output section 2207 in association with the information identifying the characteristic region.

The information identifying the cluster of the high frequency component outputted from the output section 2207 and obtained by the image obtaining section 2301 is extracted by the correspondence analyzing section 2302, and is supplied to the image generating section 2380 via the characteristic region information obtaining section 2360. The image generating section 2380 may convert the image of the object into a higher quality image, by using the high frequency component representative of the cluster of the high frequency component stored in the model storage section 2350 in association with the information identifying the cluster of the high frequency component. For example, the image generating section 2380 may add, to the image of the object, the high frequency component selected for each object with a weight corresponding to the distance up to the processing target position on the face from the center of each object. Here, the representative high frequency component may be generated by closed-loop learning. In this way, the parameter value calculating section 2260 can select, for each object, desirable learning data from among the learning data generated by performing learning according to each object. Therefore, the image generating section 2380 can sometimes render the image of the object into high image quality with higher accuracy, since it can use desirable learning data selected for each object. Although the output section 2207 has outputted the information identifying the cluster of the high frequency component in the above example, the output section 2207 may output the information identifying the cluster of the low frequency component. In such a case, the model storage section 2350 stores the cluster of the high frequency component in association with the information identifying the cluster of the low frequency component. The image generating section 2380 may render the image of the object in high image quality, by adding, to the image of the object, the high frequency component representative of the cluster of the high frequency component stored in the model storage section 2350 in association with the information identifying the cluster of the low frequency component outputted from the output section 2207.

In this way, the image processing apparatus 2120 and the image processing apparatus 2170 can reconstruct the image of a characteristic region using a principal component analysis (PCA). Note that examples of the image reconstruction method by means of the image processing apparatuses 2120 and 2170 and the learning method thereof include, other than the learning and image reconstruction by means of principal component analysis (PCA), locality preserving projection (LPP), linear discriminant analysis (LDA), independent component analysis (ICA), multidimensional scaling (MDS), support vector machine (SVM) (support vector regression), neutral network, Hidden Markov Model (HMM), Bayes estimator, Maximum a posteriori, Iterative Back Projection Method, Wavelet Conversion, locally linear embedding (LLE), Markov random field (MRF), and so on.

Note that although the above example has explained the function and operation of each constituting element of the image processing system 2010 taking an example of the two dimensional model, the image processing system 2010 may also use a three-dimensional model. Specifically, the model storage section 2270 and the model storage section 2350 may store a three-dimensional model. Note that usage of the three-dimensional model can be realized by adding, to the above-explained vector “A,” a z component representing the depth. For example, the three-dimensional model can be realized by setting the vector “A” to be (r1, g1, b1, z1, r2, g2, b2, z2, . . . , rm, gm, bm, zm).

Note that the three-dimensional model stored in the model storage section 2270 and the model storage section 2350 may be generated by using the three-dimensional image generated from the plurality of sample images obtained by capturing images of an object from respectively different directions. For example, for each of three-dimensional images of the plurality of objects, the three-dimensional model can be generated using the same method as used in generating the above-explained two dimensional model. Then, the parameter value calculating section 2260 calculates the value of the feature parameter by identifying the characteristic regions including the same object in respectively different directions, from among the characteristic regions in the plurality of captured images, and adapting, to the three-dimensional model, the three-dimensional image of the object included in the identified characteristic region based on the image of the object. Note that the parameter value calculating section 2260 can generate the three-dimensional image of the object, based on parallax information in the images of the same object captured in respectively different directions. Moreover, the direction in which the image of the object included in each characteristic region was captured can be identified based on the parallax information. The output section 2207 may output the image capturing direction in association with the image of the region other than the characteristic region and the value of the feature parameter.

The image generating section 2380 generates the three-dimensional image of the object included in the images of the characteristic regions including the same object in respectively different directions, based on the value of the feature parameter and from the three-dimensional model, and based on the generated three-dimensional image, generates the two dimensional image of the object included in the images of the characteristic regions. Note that the characteristic region information obtaining section 2360 obtains, through the image obtaining section 2301, the image capturing direction outputted from the output section 2207, and supplies the obtained image capturing direction to the image generating section 2380. The image generating section 2380 can generate the two dimensional image of the object by projection into a two dimensional space based on the image capturing direction and the three-dimensional image. Then, the output section 2340 outputs the two dimensional image generated by the image generating section 2380 and the image of the region other than the characteristic region obtained by the image obtaining section 2301. Note that the image capturing direction stated above is an example of direction information used for generating a two dimensional image from a three-dimensional image, and the direction information may be a projection angle at which three-dimensional data is projected onto a two dimensional space.

When the difference between the image of the object included in the captured image and the average image (e.g., average facial image) is larger than a predetermined value, the compression section 2230 can compress the image of the characteristic region. Accordingly, when the image of the object included in the characteristic region is largely different from the average image, substantial reduction in the reconstruction accuracy can be avoided.

Note that when the reference model is represented by the value of the feature parameter in the image processing apparatus 120 explained with reference to FIG. 1 through FIG. 9, the difference information between the reference model outputted from the output section 207 and the object model can be a differential value between the value of the feature parameter representing the reference model and the value of the feature parameter representing the object model.

Still further, the output section 207 may select between outputting the difference information between the reference model and the object model, and outputting the value of the feature parameter. The output section 207 may output the difference information between the reference model and the object model, when the image quality versus the compression ratio of the image obtained as a result of outputting the difference information between the reference model and the object model is higher than the image quality versus the compression ratio obtained as a result of outputting the value of the feature parameter. Conversely, when the image quality versus the compression ratio of the image obtained as a result of outputting the difference information between the reference model and the object model is lower than the image quality versus the compression ratio obtained as a result of outputting the value of the feature parameter, the output section 207 may output the value of the feature parameter.

Still further, the output section 207 may base, on the type of the object, selection between outputting the difference information between the reference model and the object model, and outputting the value of the feature parameter. For example, it can select to output the difference information for the image of the object for which outputting of the difference information is suitable, and to output the value of the feature parameter for the image of the object for which outputting of the value of the feature parameter is suitable. The determination on which of outputting of the difference information and the value of the feature parameter is suitable can be performed on an object basis. Concretely, the output section 207 may output the difference information between the reference model and the object model, for the image of the object for which the image quality versus the compression ratio obtained as a result of outputting the difference information between the reference model and the object model is higher than the image quality versus the compression ratio obtained as a result of outputting the value of the feature parameter. Conversely, for the image of the object for which the image quality versus the compression ratio obtained as a result of outputting the difference information between the reference model and the object model is lower than the image quality versus the compression ratio obtained as a result of outputting the value of the feature parameter, the output section 207 may output the value of the feature parameter.

In the above statement, the image quality versus compression ratio is used as an index to select which of the difference information and the value of the feature parameter is to be outputted, however instead, the index may be one of the compression ratio or the image quality. Note that some examples of the image quality index are PSNR (peak signal-to-noise ratio) and SSIM (structural similarity). It is also possible to select which of the difference information and the value of the feature parameter is to be outputted, based on the calculation accuracy of the object model. The output section 207 may output the difference information when the object model has been calculated at an accuracy higher than a predetermined value, and output the value of the feature parameter when the object model has been calculated at an accuracy lower than or equal to the predetermined value. For example, when the object is captured in more directions, it is considered natural that the object model can be calculated at a higher accuracy. With this in view, the output section 207 may output the difference information for the object having been image-captured in different directions in a greater number, and output the value of the feature parameter for the object having been image-captured in different directions in a smaller number.

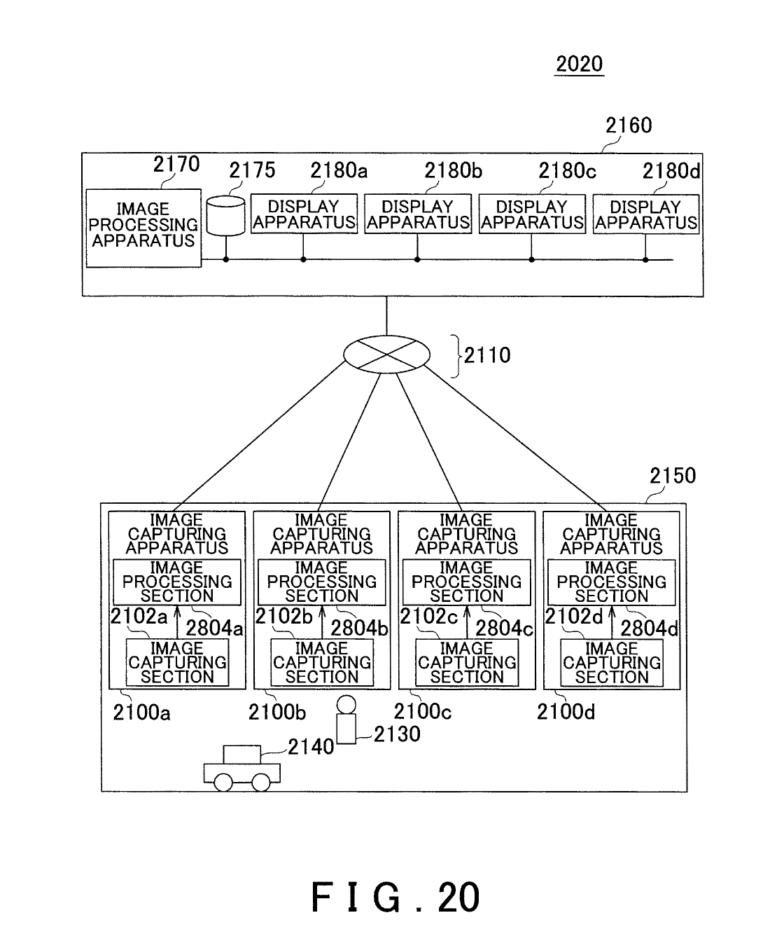

FIG. 20 shows an example of an image processing system 2020 according to another embodiment. The configuration of the image processing system 2020 in the present embodiment is the same as the configuration of the image processing system 2010 of FIG. 10, except that the image capturing apparatuses 2100a-d respectively include image processing sections 2804a-d (hereinafter collectively referred to as “image processing section 2804”).

The image processing section 2804 includes all the constituting elements of the image processing apparatus 2120 except for the image obtaining section 2250. The function and operation of each constituting element of the image processing section 2804 may be substantially the same as the function and operation of each constituting element of the image processing apparatus 2120, except that each constituting element of the image processing section 2804 processes the captured moving image captured by the image capturing section 2102 instead of processing the captured moving image obtained by expanding processing performed by the compressed moving image expanding section 2202. The image processing system 2020 having the stated configuration can also obtain substantially the same effect as the effect obtained by the image processing system 2010 explained above with reference to FIG. 10 through FIG. 19.

Note that the image processing section 2804 may obtain, from the image capturing section 2102, a captured moving image including a plurality of captured images represented in RAW format, and compress the plurality of captured images represented in RAW format (e.g., an image of a region other than a characteristic region) in the obtained captured moving image, as they are in the RAW format. Note that the image processing section 2804 may detect one or more characteristic regions from a plurality of captured images represented in RAW format. The image processing section 2804 may further compress the captured moving image including the plurality of compressed captured images represented in RAW format. The image processing section 2804 can perform compression using a compression method explained above as the operation of the image processing apparatus 2120 with reference to FIG. 10 through FIG. 20. The image processing apparatus 2170 can obtain the plurality of captured images represented in RAW format (e.g., an image of a region other than a characteristic region), by expanding the moving image obtained from the image processing section 2804. The image processing apparatus 2170 enlarges, for each region, the plurality of captured images represented in RAW format obtained by expansion, and performs synchronization processing for each region. During this operation, the image processing apparatus 2170 may perform higher definition synchronization processing on the characteristic regions than in the region other than the characteristic regions.

The amount of operation increases if encoding using the model for the entire region of the image. Moreover the accuracy in reconstruction may be lowered if encoding by using the model also for regions of low importance. The image processing system 2020 may solve these problems.

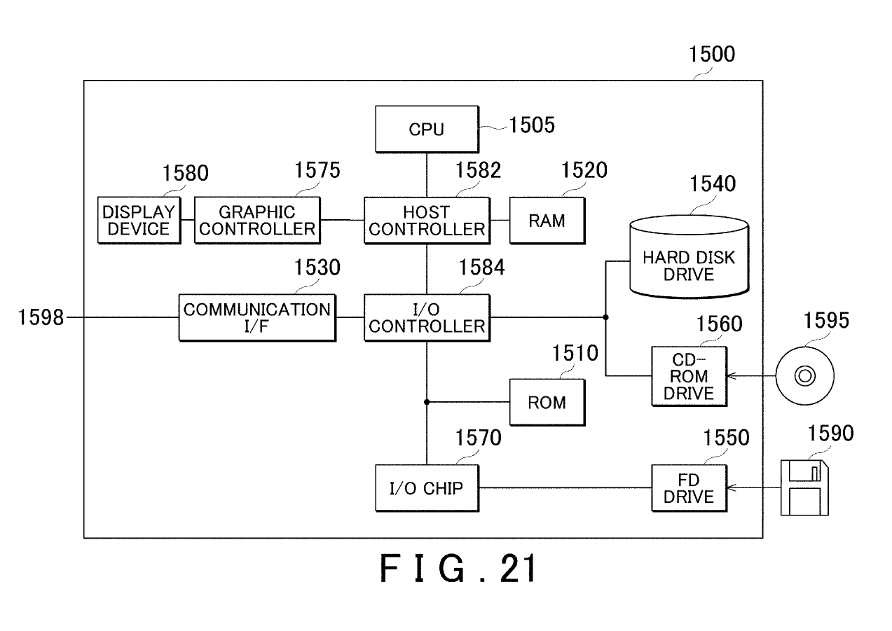

FIG. 21 shows an example of a hardware configuration of a computer 1500 functioning as an image processing apparatus 120, an image processing apparatus 170, an image processing apparatus 2120, and an image processing apparatus 2170. The computer 1500 includes a CPU peripheral section, an input/output section, and a legacy input/output section. The CPU peripheral section includes a CPU 1505, a RAM 1520, a graphic controller 1575, and a display device 1580 connected to each other by a host controller 1582. The input/output section includes a communication interface 1530, a hard disk drive 1540, and a CD-ROM drive 1560, all of which are connected to the host controller 1582 by an input/output controller 1584. The legacy input/output section includes a ROM 1510, a flexible disk drive 1550, and an input/output chip 1570, all of which are connected to the input/output controller 1584.

The host controller 1582 is connected to the RAM 1520 and is also connected to the CPU 1505 and the graphic controller 1575 accessing the RAM 1520 at a high transfer rate. The CPU 1505 operates to control each section based on programs stored in the ROM 1510 and the RAM 1520. The graphic controller 1575 obtains image data generated by the CPU 1505 or the like on a frame buffer provided inside the RAM 1520 and displays the image data in the display device 1580. Alternatively, the graphic controller 1575 may internally include the frame buffer storing the image data generated by the CPU 1505 or the like.

The input/output controller 1584 connects the communication interface 1530 serving as a relatively high speed input/output apparatus, the hard disk drive 1540, and the CD-ROM drive 1560 to the host controller 1582. The hard disk drive 1540 stores the programs and data used by the CPU 1505. The communication interface 1530 transmits or receives programs and data by connecting to the network communication apparatus 1598. The CD-ROM drive 1560 reads the programs and data from a CD-ROM 1595 and provides the read programs and data to the hard disk drive 1540 and to the communication interface 1530 via the RAM 1520.

Furthermore, the input/output controller 1584 is connected to the ROM 1510, and is also connected to the flexible disk drive 1550 and the input/output chip 1570 serving as a relatively low speed input/output apparatus. The ROM 1510 stores a boot program executed when the computer 1500 start up, a program relying on the hardware of the computer 1500, and so on. The flexible disk drive 1550 reads programs or data from a flexible disk 1590 and supplies the read programs or data to the hard disk drive 1540 and to the communication interface 1530 via the RAM 1520. The input/output chip 1570 is connected to a variety of input/output apparatuses via the flexible disk drive 1550, and a parallel port, a serial port, a keyboard port, a mouse port, or the like, for example.

A program executed by the CPU 1505 is supplied by a user by being stored in a recording medium such as the flexible disk 1590, the CD-ROM 1595, or an IC card. The program may be stored in the recording medium either in a decompressed condition or a compressed condition. The program is installed via the recording medium to the hard disk drive 1540, and is read by the RAM 1520 to be executed by the CPU 1505. The program executed by the CPU 1505 causes the computer 1500 to function as each constituting element of the image processing apparatus 120 explained with reference to FIGS. 1 through 9. The program executed by the CPU 1505 causes the computer 1500 to function as each constituting element of the image processing apparatus 170 explained with reference to FIGS. 1 through 9. The program executed by the CPU 1505 causes the computer 1500 to function as each constituting element of the image processing apparatus 2120 explained with reference to FIGS. 10 through 20. The program executed by the CPU 1505 causes the computer 1500 to function as each constituting element of the image processing apparatus 2170 explained with reference to FIGS. 11 through 20.

The programs shown above may be stored in an external storage medium. In addition to the flexible disk 1590 and the CD-ROM 1595, an optical recording medium such as a DVD or PD, a magnetooptical medium such as an MD, a tape medium, a semiconductor memory such as an IC card, or the like can be used as the recording medium. Furthermore, a storage apparatus such as a hard disk or a RAM disposed in a server system connected to a dedicated communication network or the Internet may be used as the storage medium and the programs may be provided to the computer 1500 functioning as the image processing apparatuses 120, 170, 2120, and 2170 via the network. In this way, the computer 1500 controlled by a program functions as the image processing apparatuses 120, 170, 2120, and 2170.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An image processing apparatus comprising:
a model storage section that stores a reference model that is a three-dimensional model representing an object;
a model generating section that generates, based on a plurality of captured images of an object, an object model that is a three-dimensional model that matches the object captured in the plurality of captured images; and
an output section that outputs a position and a direction of the object captured in each of the plurality of captured images, in association with difference information between the reference model and the object model.

2. The image processing apparatus according to claim 1, wherein
the model generating section generates the object model by changing the reference model, and
the output section outputs the position and the direction of the captured object, in association with the difference information representing an amount of change from the reference model resulting from generating the object model by means of the model generating section.

3. The image processing apparatus according to claim 2, wherein
the model storage section stores a plurality of reference models,
the model generating section generates the object model by changing a reference model selected from the plurality of reference models, and
the output section outputs the position and the direction of the captured object, in association with information identifying the selected reference model and the difference information.

4. The image processing apparatus according to claim 3, wherein
the model storage section stores the plurality of reference models for each portion of an object,
the model generating section generates the object model for each portion of an object by selecting the reference model for the portion and changing the reference model selected for the portion.

5. The image processing apparatus according to claim 3, further comprising:
an allowable amount storage section that stores an allowable range of an amount of change allowed from the reference model, wherein
the model generating section generates the object model by changing the reference model within the allowable range of the amount of change stored in the allowable amount storage section.

6. The image processing apparatus according to claim 3, further comprising:
an image capturing information identifying section that identifies, based on the object model and a captured image, an illumination condition under which the object captured in the captured image is illuminated, wherein
the output section outputs the position and the direction of the captured object, in association with the difference information and the illumination condition.

7. The image processing apparatus according to claim 1, further comprising:
a characteristic region detecting section that detects a characteristic region from each of the plurality of captured images, wherein
the model generating section generates the object model based on the plurality of captured images including an object captured in the characteristic region, and
the output section outputs, in association with the difference information, the position and the direction of the object captured in the characteristic region detected from each of the plurality of captured images.

8. The image processing apparatus according to claim 7, wherein
the output section outputs, in association with the difference information, the position and the direction of the object captured in the characteristic region detected from each of the plurality of captured images, as well as outputting an image of a region other than the characteristic region in each of the plurality of captured images.

9. The image processing apparatus according to claim 7, wherein
the output section outputs, in association with the difference information, the position and the direction of the object captured in the characteristic region detected from each of the plurality of captured images, as well as outputting a low resolution image of a region other than the characteristic region in each of the plurality of captured images.

10. The image processing apparatus according to claim 9, further comprising:
an object model storage section that stores the object model generated by the model generating section, wherein
the characteristic region detecting section detects, from a newly captured image, a region including an object matching the object model, as the characteristic region.

11. The image processing apparatus according to claim 1, wherein
the model storage section stores a three-dimensional model representing an object by a feature parameter,
the image processing apparatus further comprises:
a characteristic region detecting section that detects a characteristic region from a captured image; and
a parameter value calculating section that calculates a value of the feature parameter of the three-dimensional model representing an object included in an image of the characteristic region, by adapting an image of the object included in the image of the characteristic region in the captured image, to the three-dimensional model stored in the model storage section, and
the output section outputs the value of the feature parameter calculated by the parameter value calculating section and the image of the region other than the characteristic region.

12. The image processing apparatus according to claim 11, further comprising:
a compression section that compresses the image of the region other than the characteristic region, by lowering an image quality of the image of the region other than the characteristic region, wherein
the output section outputs the value of the feature parameter calculated by the parameter value calculating section and the image of the region other than the characteristic region whose image quality has been lowered by the compression section.

13. The image processing apparatus according to claim 12, wherein
the model storage section stores the three-dimensional model representing an object by a statistical feature parameter.

14. An image processing method comprising:
storing a reference model that is a three-dimensional model representing an object;
generating, based on a plurality of captured images of an object, an object model that is a three-dimensional model that matches the object captured in the plurality of captured images; and
outputting a position and a direction of the object captured in each of the plurality of captured images, in association with difference information between the reference model and the object model.

15. A computer readable medium storing therein a program for an image processing apparatus, the program causing a computer to function as:
a model storage section that stores a reference model that is a three-dimensional model representing an object;
a model generating section that generates, based on a plurality of captured images of an object, an object model that is a three-dimensional model that matches the object captured in the plurality of captured images; and
an output section that outputs a position and a direction of the object captured in each of the plurality of captured images, in association with difference information between the reference model and the object model.
